(19) United States
(12) Patent Application Publication
(10) Pub. No.: US 2026/0316447 A1
(43) Pub. Date: Oct. 15, 2026

(54) PRINT ELEMENT SUBSTRATE

(71) Applicant: CANON KABUSHIKI KAISHA, Tokyo (JP)

(72) Inventors: SADAYOSHI SAKUMA, Kanagawa (JP); TOSHIO NEGISHI, Kanagawa (JP)

(21) Appl. No.: 19/630,957

(22) Filed: Mar. 27, 2026

(30) Foreign Application Priority Data
Apr. 9, 2025 (JP) 2025-064382

(51) Int. Cl. B41J 2/14; B41J 2/045; B41J 2/175

(52) U.S. Cl. CPC B41J 2/14072; B41J 2/04548; B41J 2/0458; B41J 2/175; B41J 2002/14491; B41J 2202/12

(57) ABSTRACT

A print element substrate includes: a heating resistance element group in which heating resistance elements are arranged; and a drive element group in which drive elements configured to drive heating resistance elements are arranged in a region on an identical layer as a heating element region. The drive element group includes: a first drive element array in which first drive elements are arranged in an array in a first region of a drive element region; a second drive element array in which second drive elements different from the first drive elements are arranged in an array in parallel with the first drive element array, in a second region of the drive element region; and one or more inter-array wiring layers arranged on the identical layer between the first drive element array and the second drive element array and shared by the first drive elements and the second drive elements.

### BACKGROUND

### Field of the Technology

The present disclosure relates to an arrangement technique of drive elements in a print element substrate.

### Description of the Related Art

A circulation type liquid ejection apparatus that circulates an ink in a liquid ejection head has been conventionally known. Japanese Patent Laid-Open No. 2020-104493 discloses, as the circulation type liquid ejection apparatus, a configuration provided with ejection energy generation elements for ejecting an ink and circulation energy generation elements for circulating an ink. Moreover, the circulation type liquid ejection apparatus uses drive elements for driving the ejection energy generation elements and the circulation energy generation elements, respectively.

### SUMMARY

A print element substrate according to one aspect of the present disclosure includes: a heating resistance element group including a plurality of heating resistance elements being arranged; and a drive element group including a plurality of drive elements configured to drive the plurality of heating resistance elements being arranged in a region on an identical layer as a heating element region included the plurality of heating resistance elements being arranged, and the drive element group includes: a first drive element array including a plurality of first drive elements being arranged in an array in a first region in a drive element region including the plurality of drive elements being arranged; a second drive element array including a plurality of second drive elements different from the plurality of first drive elements, the plurality of second drive elements being arranged in an array in parallel with the first drive element array in a second region in the drive element region; and one or more inter-array wiring layers arranged on the identical layer between the first drive element array and the second drive element array, the inter-array wiring layers shared by the first drive elements and the second drive elements.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective diagram schematically illustrating a liquid ejection apparatus in which ink tanks are provided outside a liquid ejection head as liquid reservoirs;

FIG. 1B is a perspective diagram schematically illustrating a liquid ejection apparatus in which ink sub-tanks are provided directly above the liquid ejection head;

FIG. 2A is an exploded perspective diagram of the liquid ejection head in FIGS. 1A and 1B;

FIG. 2B is a diagram illustrating a case where the number of colors that can be ejected by one liquid ejection chip is four;

FIG. 2C is a diagram illustrating a case where the number of colors that can be ejected by one liquid ejection chip is two;

FIG. 2D is a diagram illustrating a case where the number of colors that can be ejected by one liquid ejection chip is one;

FIG. 3A is a plan diagram as viewed in a direction in which a liquid droplet is ejected from an ejection orifice of an individual ejection unit;

FIG. 3B is a IIIB-IIIB cross-sectional diagram of FIG. 3A;

FIG. 3C is a IIIB-IIIB cross-sectional diagram of FIG. 3A, and is a cross-sectional diagram in which a configuration inside a substrate is different from that in FIG. 3B;

FIG. 3D is a diagram explaining flow-in of an ink in the case where a first energy generation element is driven;

FIG. 4A is a IIIB-IIIB cross-sectional diagram of the individual ejection unit in FIG. 3A, and is a cross-sectional diagram for explaining a generation and growth process of an air bubble generated by heating the ink with a second energy generation element and causing film boiling of the ink;

FIG. 4B is an IIIB-IIIB cross-sectional diagram of the individual ejection unit in FIG. 3A, and is a cross-sectional diagram for explaining a contraction process of the air bubble generated by heating the ink with the second energy generation element and causing film boiling of the ink;

FIG. 4C is a IIIB-IIIB cross-sectional diagram of the individual ejection unit in FIG. 3A, and is a cross-sectional diagram for explaining a process after disappearing of the air bubble generated by heating the ink with the second energy generation element and causing film boiling of the ink;

FIG. 5A is a diagram illustrating a state where a circulatory flow of the ink is temporarily paused;

FIG. 5B is a diagram illustrating a state immediately after generation of the circulatory flow of the ink performed by driving the second energy generation element after the state of FIG. 5A;

FIG. 5C is a diagram illustrating a state where the circulatory flow of the ink is temporarily paused after the state of FIG. 5B;

FIG. 5D is a diagram illustrating a state immediately after generation of the circulatory flow of the ink performed by driving the second energy generation element after the state of FIG. 5C;

FIG. 6A is a diagram illustrating a state where the circulatory flow of the ink is temporarily paused;

FIG. 6B is a diagram illustrating a state immediately after generation of the circulatory flow of the ink performed by driving the second energy generation element after the state of FIG. 6A;

FIG. 6C is a diagram illustrating a state where the circulatory flow of the ink is temporarily paused after the state of FIG. 6B;

FIG. 6D is a diagram illustrating a state immediately after generation of the circulatory flow of the ink performed by driving the second energy generation element after the state of FIG. 6C;

FIG. 7A is a plan diagram as viewed in the direction in which the liquid droplet is ejected from the ejection orifice 11;

FIG. 7B is a VIIB-VIIB cross-sectional diagram of FIG. 7A;

FIG. 7C is an enlarged schematic diagram of the individual channel in FIG. 7A;

FIG. 8A is a plan diagram as viewed in the direction in which the liquid droplet is ejected from the ejection orifice 11;

FIG. 8B is a VIIIB-VIIIB cross-sectional diagram of FIG. 8A;

FIG. 8C is a VIIIB-VIIIB cross-sectional diagram of FIG. 8A, and is a cross-sectional diagram in which the configuration inside the substrate 18 is different from that in FIG. 8B;

FIG. 9A is a plan diagram as viewed in the direction in which the liquid droplet is ejected from the ejection orifice 11;

FIG. 9B is a IXB-IXB cross-sectional diagram of FIG. 9A;

FIG. 9C is a IXB-IXB cross-sectional diagram of FIG. 9A, and is a cross-sectional diagram in which the configuration inside the substrate 18 is different from that in FIG. 9B;

FIG. 10 is a diagram illustrating a circuit configuration example of a print element substrate according to the present embodiment;

FIG. 11 is a diagram illustrating an arrangement example of heaters and drive elements in a first case according to the present embodiment;

FIG. 12 is a diagram illustrating an arrangement example of the heaters and the drive elements in a second case according to the present embodiment;

FIG. 13 is a diagram illustrating an arrangement example of the heaters and the drive elements in a first comparative example;

FIG. 14 is a diagram illustrating an arrangement example of the heaters and the drive elements in a second comparative example;

FIG. 15 is a diagram illustrating an arrangement example of the heaters and the drive elements in a third case according to the present embodiment;

FIG. 16 is a diagram illustrating an enlarged example of the drive elements in the first case;

FIG. 17 is a diagram illustrating an enlarged example of the drive elements in the second case;

FIG. 18 is a diagram illustrating an enlarged example of the drive elements in the second comparative example;

FIG. 19 is a diagram illustrating a cross-sectional structure along the XIX-XIX line in FIGS. 16 and 17; and

FIG. 20 is a diagram illustrating another circuit configuration example of the print element substrate according to the present embodiment.

### DESCRIPTION OF THE EMBODIMENTS

A preferrable embodiment of the present disclosure is explained below in detail with reference to the attached drawings. Note that the following embodiment does not limit the matters of the present disclosure, and not all of combinations of features explained in the following embodiment are necessarily essential for solving means of the present disclosure. Note that identical constituent elements are denoted by identical reference numerals.

### Outline

A liquid ejection head conventionally has had a function of circulating ink to discharge air bubbles in channels of the ink and to suppress thickening of the ink near ejection orifices. A liquid ejection apparatus provided with the liquid ejection head having such a function is known as a circulation type liquid ejection apparatus. Moreover, a method using a pressure difference (hereinafter, also referred to as pressure difference method) is well-known as a method of circulating the ink. In the pressure difference method, a pressure on the ink supply side (entrance side) of each ejection orifice is set higher than a pressure on the ink collection side (exit side) of the ejection orifice by using a pressure adjustment mechanism. The ink is thereby made to flow from the entrance side to the exit side. Moreover, in order to circulate the ink, it is preferable to return the ink that has flowed to the exit side, to the entrance side. Accordingly, a pump is provided. Note that there is configuration in which the pump is provided outside the liquid ejection head in a main body of the liquid ejection apparatus, and the ink is thereby circulated between the liquid ejection head and the main body of the liquid ejection apparatus. Moreover, there is also a configuration in which the pump is provided inside the liquid ejection head, and the ink is thereby circulated in the liquid ejection head. However, in the pressure difference method, since the pressure adjustment mechanism and the pump are provided, the sizes of the main body of the liquid ejection apparatus and the liquid ejection head tend to be large.

Accordingly, circulating the ink in methods other than the pressure difference method is also studied. Specifically, there is a configuration in which a circulation channel communicating with the ejection orifices is provided, and energy generation elements (hereinafter, also referred to as circulation energy generation elements) different from energy generation elements for ejecting the ink (hereinafter, also referred to as ejection energy generation elements) are provided in this circulation channel. This configuration can circulate the ink in the circulation channel by driving the circulation energy generation elements.

A configuration in which an array of the ejection energy generation elements and an array of the circulation energy generation elements are arranged parallel to each other is known. In this configuration, the circulation energy generation elements are mounted for the respective ejection energy generation elements to form pairs. Each of the ejection energy generation elements and the circulation energy generation elements are thus manufactured to be electrically connected to a drive element and a ground line. Moreover, in a case of forming a print element substrate in a low-cost manufacturing process, an electric connection wiring layer is preferably not provided as a separate layer in addition to a conductive layer for leading out electrodes of the drive elements. Specifically, in the low-cost manufacturing process, it is preferable that the conductive layer and the wiring layer are formed of the same layer, and are formed in the same manufacturing step. Moreover, in the case where a magnitude of a driving current of the ejection drive elements differs from that of the circulation drive elements, arranging the drive elements in an array as drive elements with an identical shape, that is drive elements with an identical current driving performance is not preferable due to excessive quality. Specifically, in the case where both of the circulation drive elements and the ejection drive elements are formed in an identical size though the driving current of the circulation drive elements is smaller than the driving current of the ejection drive elements, an excessive element size of the circulation drive elements may lead to an increase in the area of the print element substrate and high cost.

The print element substrate of the present disclosure thus includes a heating resistance element group and a drive element group. In the heating resistance element group, multiple heating resistance elements are arranged. In the drive element group, multiple drive elements configured to drive the multiple heating resistance elements are arranged in a region on an identical layer as a heating element region in which the heating resistance elements are arranged. The drive element group includes a first drive element array, a second drive element array, and an inter-array wiring layer. In the first drive element array, first drive elements are arranged in an array in a first region of a drive element region that is a region in which the drive elements are arranged. In the second drive element array, second drive elements that are arranged in parallel with the first drive element array and that are different from the first drive elements are arranged in an array in a second region of the drive element region. The inter-array wiring layer is arranged between the first drive element array and the second drive element array on the identical layer, and is shared by the first drive elements and the second drive elements. According to such a configuration, an empty space is formed in the region in which the drive elements are arranged due to presence of the inter-array wiring layer. Accordingly, wiring lines that connect the drive elements and the heating resistance elements to one another can be routed in the empty space. Enabling routing of the wiring lines allows the conductive layer and the wiring layer to be provided in the same layer. Accordingly, the drive elements can be appropriately arranged in the print element substrate.

For example, assume a case where an array of the drive elements configured to drive the ejection energy generation elements and an array of the drive elements configured to drive the circulation energy generation elements are arranged in two parallel arrays. Moreover, in this case, the element size of the drive elements configured to drive the ejection energy generation elements is assumed to be different from the element size of the drive elements configured to drive the circulation energy generation elements. Furthermore, in each of the two arrays of the drive elements, two adjacent drive elements are arranged close to each other to form one unit. Arranging the drive elements close to each other in each unit as described above forms empty spaces between the drive elements. Routing ground lines and electric connection wiring lines in these empty spaces allows the wiring layer and the conductive layer in the drive elements arranged close to each other to be arranged in the same layer. In the case where the drive elements are field-effect transistors, the conductive layer is a layer in which source electrodes, gate electrodes, and drain electrodes are electrically connected to one another. The wiring layer is a layer in which wiring lines from the drive elements to the ejection energy generation elements and the circulation energy generation elements are led out. Moreover, in the case where there are the ejection energy generation elements and the circulation energy generation elements arranged adjacent to the array of the drive elements in an orthogonal direction, the elements may share a ground terminal (source wiring line) connected to the source electrodes in an array direction of the drive elements, and be connected to a common ground line. In such a connection configuration, the size of a region including lead-out portions of the ground terminals of the respective drive elements can be reduced.

### Liquid Ejection Apparatus 50

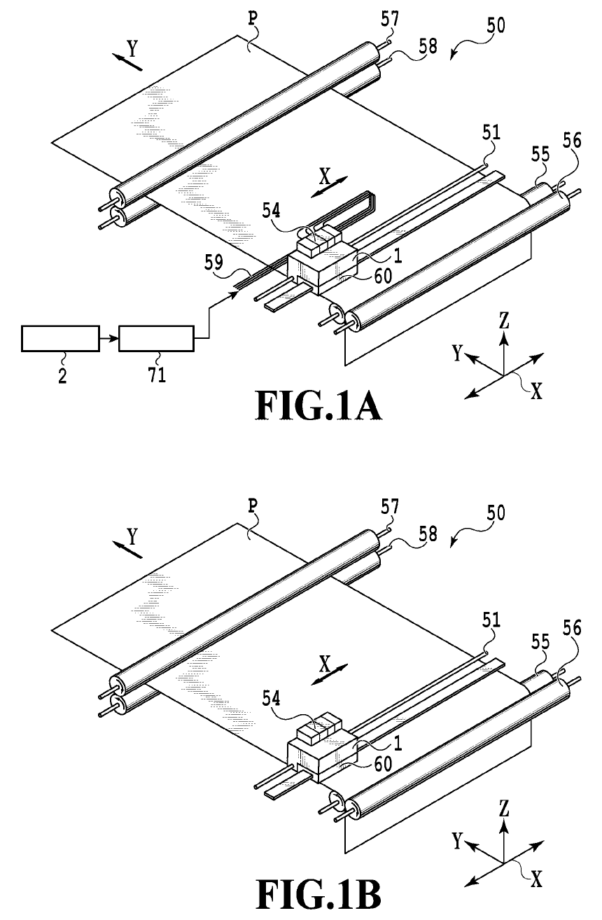

FIGS. 1A and 1B are diagrams illustrating an overall configuration example of a liquid ejection apparatus 50. FIG. 1A is a perspective diagram schematically illustrating the liquid ejection apparatus 50 in which ink tanks 2 are provided outside a liquid ejection head 1 as liquid reservoirs. FIG. 1B is a perspective diagram schematically illustrating a liquid ejection apparatus 50 in which ink sub-tanks 54 are provided directly above the liquid ejection head 1. First, portions common to FIGS. 1A and 1B are explained.

The liquid ejection apparatus 50 includes the liquid ejection head 1 and conveyance rollers 55, 56, 57, and 58. The liquid ejection head 1 can perform scanning in a direction X intersecting a conveyance direction Y of an ejection target medium P. The liquid ejection head 1 is mounted in a carriage 60. The liquid ejection head 1 is fixed to and supported on the carriage 60 by not-illustrated positioning means and an electric contact provided in the carriage 60. The carriage 60 is reciprocally moved in a main scanning direction (also referred to as direction X) along a guide shaft 51. Accordingly, the liquid ejection head 1 ejects inks while being moved in the main scanning direction together with the carriage 60 to perform printing on the ejection target medium P. The conveyance rollers 55, 56, 57, and 58 convey the ejection target medium P in a sub scanning direction (also referred to as conveyance direction Y) intersecting (orthogonal to in the present embodiment) the main scanning direction. Specifically, the liquid ejection apparatus 50 is configured as a serial type ink-jet liquid ejection apparatus by ejecting liquid from the liquid ejection head 1 to the ejection target medium P conveyed in the conveyance direction Y while performing scanning of the liquid ejection head 1 in the direction X. Note that application of the present disclosure is not limited to the serial type ink-jet liquid ejection apparatus. The present disclosure can be applied also to a page-wide type ink-jet liquid ejection apparatus that ejects liquid to the ejection target medium P conveyed in the conveyance direction Y by using a line head (page-wide head) elongating in a page width direction of the ejection target medium P. Note that a direction Z indicates the vertical direction in FIGS. 1A and 1B. Specifically, the direction Z is a direction that intersects (orthogonal to in the present embodiment) an X-Y plane specified by the direction X and the conveyance direction Y.

The liquid ejection head 1 can eject four types of inks of black (K), cyan (C), magenta (M), and yellow (Y). The liquid ejection head 1 can eject a full-color image by using these four types of inks. Note that the inks that can be ejected from the liquid ejection head 1 is not limited to the four types of inks described above. For example, the present disclosure can be applied also to a liquid ejection head 1 configured to eject other types of inks such as a special color ink. Specifically, the types and the number of the inks ejected from the liquid ejection head 1 are not limited.

Next, portions that differ between FIGS. 1A and 1B are explained. In FIG. 1A, the ink sub-tanks 54 are mounted in the liquid ejection head 1. Four ink supply tubes (liquid communication paths) 59 are attached to the ink sub-tanks 54. Moreover, the liquid ejection apparatus 50 includes the ink tanks 2 and external pumps 71. The ink tanks 2 store the inks. The inks stored in the ink tanks 2 are supplied to the ink sub-tanks 54 via the four ink supply tubes 59 by driving force of the external pumps 71. Meanwhile, in FIG. 1B, the ink sub-tanks 54 are provided directly above the liquid ejection head 1. FIG. 1B is different from FIG. 1A in that, since no ink tanks 2 are provided outside the liquid ejection head 1, no four ink supply tubes 59 are attached, or no external pumps 71 are provided. Note that, in both of FIGS. 1A and 1B, the liquid ejection head 1 may be configured to be provided integrally with the ink sub-tanks 54 and be attachable to or detachable from the carriage 60. Alternatively, the configuration may be such that the ink sub-tanks 54 are provided integrally with the carriage 60, and only the ink sub-tanks 54 can be attached to or detached from the carriage 60. The following explanation is given while using the configuration of FIG. 1A.

### Basic Configuration of Liquid Ejection Head 1

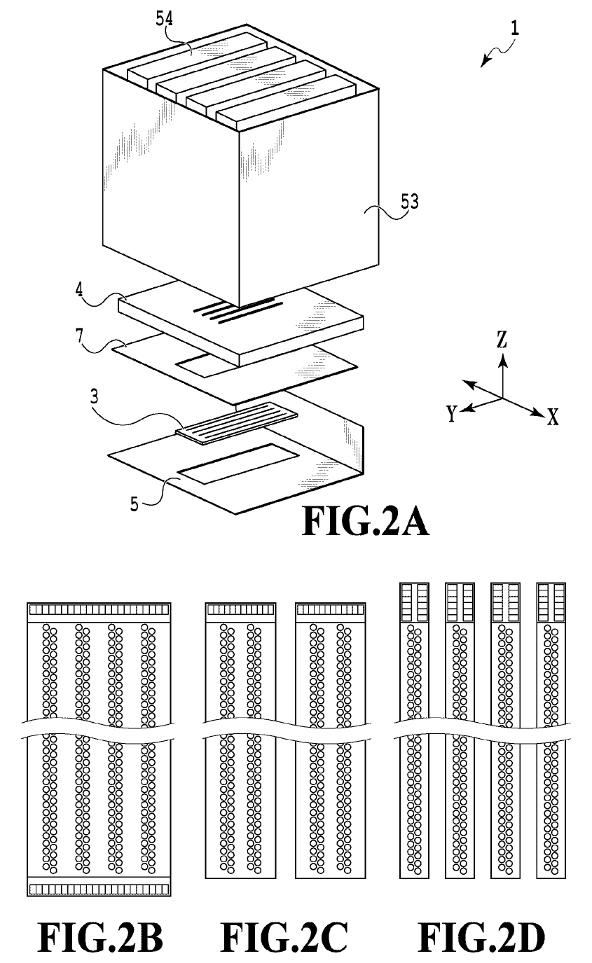

FIGS. 2A to 2D are diagrams illustrating basic configuration examples of the liquid ejection head 1 of FIGS. 1A and 1B. FIG. 2A is an exploded perspective diagram of the liquid ejection head 1 in FIGS. 1A and 1B. FIGS. 2B, 2C, and 2D are diagrams illustrating examples of a liquid ejection chip 3 in FIG. 2A. The liquid ejection head 1 includes a housing portion 53, the ink sub-tanks 54, and the liquid ejection chip 3. The ink sub-tanks 54 temporarily store the inks in the liquid ejection head 1. The ink sub-tanks 54 are housed in the housing portion 53. As described in detail later, the liquid ejection chip 3 is provided in a bottom portion of the housing portion 53. The liquid ejection chip 3 ejects the inks supplied from the ink sub-tanks 54 to the ejection target medium P.

Note that, although omitted in illustration, liquid connector insertion ports are provided on a wall surface of the housing portion 53. Liquid connector provided at front ends of the ink supply tubes 59 in FIG. 1A are inserted and connected to these liquid connector insertion ports in a liquid-tight manner. This configuration forms the ink supply paths extending from the ink tanks 2 to the liquid ejection head 1 via the external pumps 71. In the present embodiment, the four types of inks are used. Accordingly, four sets of the ink tank 2, the external pump 71, the ink supply tube 59, and the ink sub-tank 54 are provided to correspond to the respective inks. Thus, four ink supply paths corresponding to the respective inks are independently formed. As described above, in the present embodiment, the liquid ejection apparatus 50 includes an ink supply system in which the inks are supplied from the ink tanks 2 provided outside the liquid ejection head 1.

A first supporting member 4 and a second supporting member 7 are provided between the housing portion 53 and the liquid ejection chip 3. An electric wiring member 5 is provided below the liquid ejection chip 3. Specifically, ink supply ports and ink collection ports are provided in the first supporting member 4. An opening is provided in the second supporting member 7. The liquid ejection chip 3 is bonded and fixed to the first supporting member 4. The first supporting member 4 is bonded and fixed to the second supporting member 7. The second supporting member 7 holds the electric wiring member 5 such that the electric wiring member 5 is electrically connected to the liquid ejection chip 3. The electric wiring member 5 applies electric signals for ejecting the inks and electric signals for circulating the inks to the liquid ejection chip 3.

Note that, in the present embodiment, the liquid ejection apparatus 50 does not include an ink collection system that collects the inks in the liquid ejection head 1 into the ink tanks 2. Accordingly, the liquid ejection head 1 is provided with the liquid connector insertion ports for connecting the liquid connectors of the ink supply tubes 59, but is not provided with connector insertion ports for connecting tubes configured to collect the inks into the ink tanks 2.

FIG. 2B illustrates a case where the liquid ejection chip 3 has a configuration of one chip per four colors. Specifically, FIG. 2B illustrates a case where the number of colors that can be ejected from one liquid ejection chip 3 is four. The liquid ejection chip 3 includes multiple ejection orifices and pads used for electrical mounting. The four colors are, for example, black, cyan, magenta, and yellow, and arrays are provided separately for the respective colors. Each array is formed along the conveyance direction Y, and the arrays are arranged at intervals along the direction X. Each array includes multiple ejection orifices. Multiple ejection orifices are arranged at equal intervals along the Y direction. The ejection orifices in each array may be arranged in one array along the Y direction without being arranged at intervals in the X direction. Alternatively, the configuration may be such that only the ejection orifices for black are arranged in two arrays, the ejection orifices for the other three colors are arranged in three arrays, and the ejection orifices for the four colors are arranged in a total of five arrays. Note that the liquid ejection chip 3 of FIG. 2A illustrates a configuration example of one chip per four colors. Specifically, the liquid ejection chip 3 of FIG. 2A illustrates one example of the case of FIG. 2B.

FIG. 2C illustrates a case where the liquid ejection chip 3 has a configuration of one chip per two colors. In this case, two chips are used. Specifically, FIG. 2C illustrates a case where the number of colors that can be ejected from one liquid ejection chip 3 is two. In the case where the liquid ejection chip 3 is mounted in the liquid ejection head 1, two liquid ejection chips 3 may be mounted in one liquid ejection head 1, or two liquid ejection heads 1 in each of which one liquid ejection chip 3 is mounted may be prepared.

FIG. 2D illustrates a case where the liquid ejection chip 3 has a configuration of one chip per one color. In this case, four chips are used. Specifically, FIG. 2D illustrates a case where the number of colors that can be ejected from one liquid ejection chip 3 is one. In the case where the liquid ejection chip 3 is mounted in the liquid ejection head 1, four liquid ejection chips 3 may be mounted in one liquid ejection head 1, or four liquid ejection heads 1 in each of which one liquid ejection chip 3 is mounted may be prepared.

Note that, assuming the case where multiple liquid ejection chips 3 are mounted in one liquid ejection head 1 as in FIGS. 2C and 2D, the liquid ejection chips 3 do not have to have the same chip length. Moreover, the number of colors of the liquid ejection chip 3 is not limited to a particular number, and combinations of various numbers of colors may be adopted. For example, although the example in which the number of colors of the liquid ejection chip 3 in FIG. 2A is four is described, the number of colors of the liquid ejection chip 3 may be more than four.

### Individual Channel: Straight Type

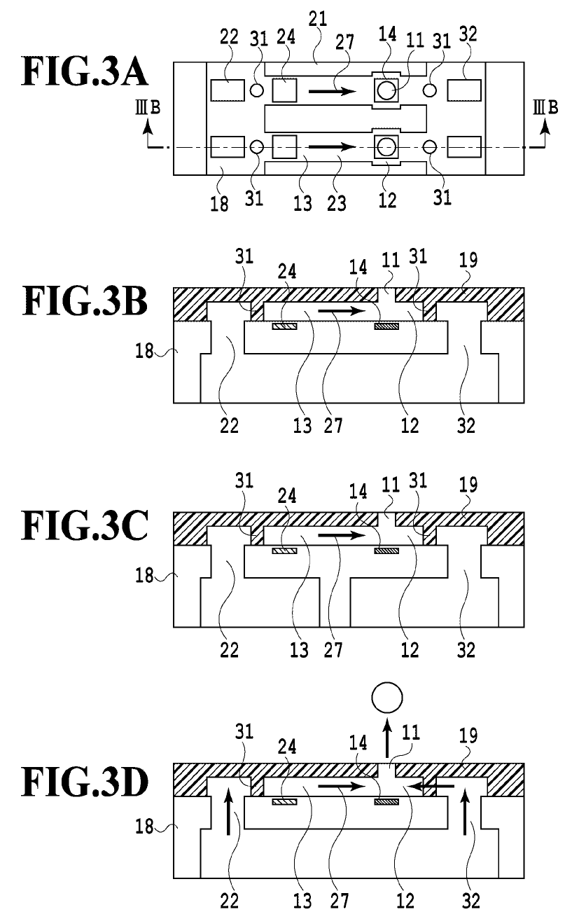

The liquid ejection head 1 includes multiple individual ejection units including individual channels. The liquid ejection head 1 also includes a supply channel for supplying the liquid to the individual channels of the respective individual ejection units. FIGS. 3A, 3B, 3C, and 3D are diagrams explaining a portion near each of ejection orifices 11 of the individual ejection units including straight type individual channels 23. FIG. 3A is a plan diagram as viewed in a direction in which a liquid droplet is ejected from the ejection orifice 11 of the individual ejection unit. FIG. 3B is a IIIB-IIIB cross-sectional diagram of FIG. 3A. FIG. 3C is a IIIB-IIIB cross-sectional diagram of FIG. 3A, and is a cross-sectional diagram in which a configuration inside a substrate 18 is different from that in FIG. 3B.

Each of the individual ejection units includes the ejection orifice 11, a pressure chamber 12, a first energy generation element 14 (also referred to as ejection energy generation element 14), and a second energy generation element 24 (also referred to as circulation energy generation element 24).

The pressure chamber 12 is formed to correspond to each ejection orifice 11 by partitioning a space between the substrate 18 and an orifice plate 19 with a partition 21. The ejection orifice 11 is an opening formed in a portion of the orifice plate 19. A meniscus of the ink flowing through the pressure chamber 12 is formed in the ejection orifice 11, and an ejection orifice interface is formed as an interface between the ink and the atmosphere. The ejection orifice 11 ejects the liquid.

The individual channel 23 extends in a second direction intersecting (orthogonal to in the present embodiment) a direction (first direction) in which the ejection orifices 11 are arranged to form an array. The individual channel 23 includes the pressure chamber 12, an entrance (upstream) side connection channel 13, and an exit (downstream) side connection channel. The entrance side connection channel 13 communicates with one end portion of the pressure chamber 12. The exit side connection channel communicates with the other end portion of the pressure chamber 12.

A first supply opening 22 is provided on the one end side of the individual channel 23. The first supply opening 22 is an opening that extends from a not-illustrated common channel to the upstream side of the individual channel 23 by passing through the inside of the substrate 18. A second supply opening 32 is provided on the other end side of the individual channel 23. The second supply opening 32 is an opening that extends from the not-illustrated common channel to the downstream side of the individual channel 23 by passing through the inside of the substrate 18. The liquid is supplied to the individual channel 23 via the first supply opening 22 and the second supply opening 32.

In the substrate 18, the first energy generation element 14 is formed closer to the second supply opening 32 than to the first supply opening 22. The first energy generation element 14 is an element for generating energy for ejecting the liquid in the pressure chamber 12 from the ejection orifice 11. Specifically, the first energy generation element 14 is driven to generate heat, and causes bubbling of the liquid (also referred to as ink) in the pressure chamber 12. The first energy generation element 14 can thereby eject the ink from the ejection orifice 11 by using this bubble generating energy. An electrothermal transducing element is used as the first energy generation element 14 in the present embodiment. However, the first energy generation element 14 is not limited to a particular element. For example, a piezoelectric element may be used as the first energy generation element 14.

In the substrate 18, the second energy generation element 24 is formed closer to the first supply opening 22 than to the second supply opening 32. The second energy generation element 24 is an element that generates energy for causing a circulatory flow of the ink in the individual channel 23 in a direction illustrated by the arrow 27. An electrothermal transducing element is used as the second energy generation element 24 in the present embodiment. However, the second energy generation element 24 is not limited to a particular element. For example, a piezoelectric element may be used as the second energy generation element 24.

Explanation of a straight type is given. The straight type means that the shape of the individual channel 23 is configured such that both end portions of the individual channel 23 are located on the both sides of the ejection orifice 11, and a direction passing through the both end portions of the individual channel 23 extends in a direction intersecting the direction along the array of the ejection orifices 11 (in a direction orthogonal to the direction along the array of the ejection orifices 11 in the example of FIG. 3A). In other words, in the individual channel 23, the first energy generation element 14 and the second energy generation element 24 are arranged in a direction intersecting the direction along the array of the ejection orifices 11.

Moreover, the entrance side connection channel 13 is formed on the second energy generation element 24 side. The entrance side connection channel 13 is formed of the first supply opening 22 and a portion of the individual channel 23 on the second energy generation element 24 side. Meanwhile, a flow-out channel is formed on the first energy generation element 14 side. The flow-out channel is formed of the second supply opening 32 and another portion of the individual channel 23 on the first energy generation element 14 side.

Next, a flow of the ink flowing in the individual channel 23 is explained. The flow of the ink flowing in the individual channel 23 is categorized into two types. A first ink flow is a flow for refill performed after the liquid ejection apparatus 50 drives the first energy generation element 14 and ejects the ink from the ejection orifice 11. A second ink flow is a flow in which the liquid ejection apparatus 50 drives the second energy generation element 24 to generates a circulatory flow in the direction of the arrow 27.

### First Ink Flow

How the liquid ejection apparatus 50 drives the first energy generation element 14 and ejects the ink from the ejection orifice 11 is illustrated in FIG. 3D. FIG. 3D is a diagram explaining flow-in of the ink in the case where the first energy generation element 14 is driven. In the example of FIG. 3D, the ink is supplied from each of the first supply opening 22 and the second supply opening 32 with the ejection of the ink from the ejection orifice 11. Accordingly, the ink flows into the pressure chamber 12 from both of the first supply opening 22 and the second supply opening 32.

### Second Ink Flow

Meanwhile, in the case where the second energy generation element 24 is driven to generate the circulatory flow, the ink flows into the individual channel 23 through the first supply opening 22, and flows out from the individual channel 23 through the second supply opening 32. In the present embodiment, the liquid ejection apparatus 50 generates the circulatory flow of the ink in the individual channel 23 in the direction illustrated by the arrow 27 by returning the ink flowing out from the second supply opening 32 to the first supply opening 22 to circulate the ink. FIG. 3C illustrates an example in which the first supply opening 22 and the second supply opening 32 become a common channel in the liquid ejection chip 3. FIG. 3D is an example in which each of the first supply opening 22 and the second supply opening 32 is provided as an individual channel and the individual channels become a common channel outside the liquid ejection head 1.

The circulatory flow of the ink is further explained. The ink includes solid contents and volatile components such as water. In use of the liquid ejection head 1, there is a case where ejection of the ink from the ejection orifice 11 is destabilized due to evaporation of the volatile components in the ink from the ejection orifice 11, a concentration increase of the solid contents in the ink near the ejection orifice 11 with the evaporation of the volatile components in the ink, and the like. Accordingly, various efforts are made to prevent destabilization of the ejection of the ink from the ejection orifice 11.

For example, a not-illustrated cap member may be provided at a position outside a conveyance path of the ejection target medium P in the X direction. The shape of this cap member is formed in such a shape that the cap member can cover an ejection orifice surface on which the ejection orifices 11 of the liquid ejection head 1 are provided. The cap member can prevent drying of the ejection orifices 11 and protect the ejection orifices 11 by covering the ejection orifice surface on which the ejection orifices 11 of the liquid ejection head 1 are provided, in the case where the liquid ejection head 1 is not performing a printing operation on the ejection target medium P.

Moreover, a not-illustrated ink suction mechanism may be provided. In the case where the cap member and the ink suction mechanism are provided, the cap member is used in cooperation with an ink suction operation from the ejection orifices 11. Since the ink suction operation refreshes the ink near the ejection orifices 11, an image quality of an obtained image can be maintained.

Furthermore, the concentrated ink can be disposed by performing an ejection operation referred to as preliminary ejection (also referred to as preliminary discharging) in the case where the liquid ejection head 1 is not performing the printing operation on the ejection target medium P. Moreover, there is known a method in which an ejection operation referred to as preliminary ejection (also referred to as paper surface preliminary ejection or in-page preliminary ejection) is performed in the case where the liquid ejection head 1 is performing the printing operation on the ejection target medium P. The paper surface preliminary ejection or the in-page preliminary ejection is an ejection operation in which the ink of an unnoticeable amount is ejected to a position unnoticeable in terms of image quality on the ejection target medium P. Although these ejection operations greatly contribute to improving of the image quality of the image, part of the ink is disposed to refresh the ejection orifices 11. Accordingly, there is a demand to preferably reduce a waste ink amount as much as possible.

The second energy generation elements 24 that heats the ink in the individual channels 23 are thus provided in the substrate 18 to enable generation of the circulatory flow of the ink. This circulatory flow of the ink can suppress drying of the ejection orifices 11 and the concentration increase of the ink near the ejection orifices 11 while suppressing the waste ink amount. From another perspective, the number of times of the preliminary ejection of the ink and the suction of the ink can be minimized. Moreover, minimizing the number of times of the preliminary ejection of the ink can improve throughput and yield of the entire liquid ejection apparatus 50. Note that the second energy generation elements 24 can provide the above-mentioned effects by being provided in at least some of the individual channels 23 among the multiple individual channels 23 included in the liquid ejection head 1.

Moreover, the liquid ejection head 1 of FIG. 1A may have a configuration in which the second energy generation elements 24 are provided in all portions corresponding to the four types of inks, or have a configuration in which the second energy generation elements 24 are provided only in portions corresponding to one type of ink. Specifically, the liquid ejection head 1 may have a configuration in which at least one of the multiple types of inks is circulated.

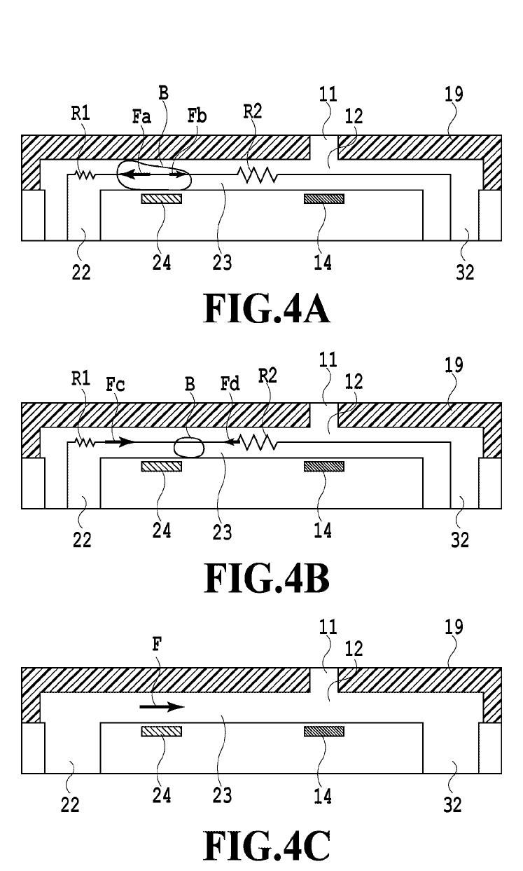

Note that filters 31 as illustrated in FIG. 3A may be provided in the circulation channel of the ink to remove foreign substances included in the ink. The filters 31 are protrusions formed by causing part of the orifice plate 19 to protrude toward the substrate 18. In the examples of FIGS. 3A to 3D, the filters 31 are provided at a position on one end side and a position on the other end side of each individual channel 23. In the circulation channel of the ink, the one end side of the individual channel 23 corresponds to the flow-in side of the ink, and the other end side of the individual channel 23 corresponds to the flow-out side of the ink. The filters 31 may be provided at positions between the first energy generation element 14 and the second energy generation element 24 in the individual channel 23. In the case where the filters 31 are provided at positions between the first energy generation element 14 and the second energy generation element 24 in the individual channel 23, the filters 31 do not have to be provided at the position on the one end side and the position on the other end side of the individual channel 23. Next, a principle of ink circulatory flow generation is explained by using FIGS. 4A to 4C.

### Principle of Ink Circulatory Flow Generation

FIGS. 4A to 4C are diagrams for explaining the principle of the ink circulatory flow generation. In FIGS. 4A to 4C, illustration of the filters 31 is omitted to facilitate explanation. FIG. 4A is a IIIB-IIIB cross-sectional diagram of the individual ejection unit in FIG. 3A, and is a cross-sectional diagram for explaining a generation and growth process of an air bubble B generated by heating the ink with the second energy generation element 24 and causing film boiling of the ink. FIG. 4B is an IIIB-IIIB cross-sectional diagram of the individual ejection unit in FIG. 3A, and is a cross-sectional diagram for explaining a contraction process of the air bubble B generated by heating the ink with the second energy generation element 24 and causing film boiling of the ink. FIG. 4C is a IIIB-IIIB cross-sectional diagram of the individual ejection unit in FIG. 3A, and is a cross-sectional diagram for explaining a process after disappearing of the air bubble B generated by heating the ink with the second energy generation element 24 and causing film boiling of the ink. Next, the generation and growth process, the contraction process, and the process after the disappearing of the air bubble B are explained.

### Generation and Growth Process of Air Bubble B

As illustrated in FIG. 4A, the second energy generation element 24 is arranged at a position closer to the first supply opening 22 out of the first supply opening 22 and the second supply opening 32. Accordingly, a flow resistance R1 generated in a channel between the second energy generation element 24 and the first supply opening 22 in response to generation of a certain circulation amount of the ink is smaller than a flow resistance R2 generated in a channel between the second energy generation element 24 and the second supply opening 32. Thus, as illustrated in FIG. 4A, a difference between the flow resistance R1 and the flow resistance R2 causes the air bubble B generated by the film boiling of the ink to grow while being biased toward the channel of the relatively-smaller flow resistance R1. A flow vector Fa of the ink flowing toward the channel on the side where the flow resistance R1 is generated is thus larger than a flow vector Fb of the ink flowing toward the channel on the side where the flow resistance R2 is generated. Note that a circuit including the flow resistances R1 and R2 is equivalent to a circuit in which the flow resistances generated by the circulatory flow of the ink in a channel including the individual channel 23 are expressed by an analogy to electric resistances.

### Contraction Process of Air Bubble B

In the contraction process of the air bubble B, the ink flows in to fill a volume corresponding to contraction of the air bubble B. In this case, as illustrated in FIG. 4B, a flow vector Fc of the ink flowing in from the first supply opening 22 on the flow resistance R1 side is larger than a flow vector Fd of the ink flowing in from the second supply opening 32 on the flow resistance R2 side. Moreover, the disappearing position of the air bubble B is shifted from the position above the second energy generation element 24 to a portion of the channel closer to the second supply opening 32.

### Process after Disappearing of Air Bubble B

As explained by using FIG. 4B, a relationship of Fc>Fd is established. Accordingly, a flow vector F of the circulatory flow of the ink from the first supply opening 22 toward the second supply opening 32 is generated. The magnitude of the flow vector F is affected by a ratio between the flow resistances R1 and R2 and the size of the air bubble B. For example, assume a case where the second energy generation element 24 is used. In this case, an arrangement position of the second energy generation element 24 is preferably closer to one of both end portions of the individual channel 23 than to an arrangement position of the first energy generation element 14. Specifically, the flow resistance ratio R1/R2 is preferably set in a range of 0.05 to 0.40. Setting the flow resistance ratio R1/R2 in the range of 0.05 to 0.40 allows the flow vector F of the circulatory flow of the ink to be set at a local maximum value. Increasing the flow vector Fa of the ink and increasing the flow vector Fc of the ink increases the flow vector F of the circulatory flow of the ink, and increases the circulatory flow of the ink. Accordingly, it is preferable to reduce the flow resistance R1 as much as possible. Moreover, it is preferable to reduce the flow vector Fb of the ink as much as possible and reduce the flow vector Fd of the ink. Accordingly, it is preferable to increase the flow resistance R2. In view of this, it is preferable to reduce the flow resistance R1 and increase the flow resistance R2. Specifically, reducing the flow resistance ratio R1/R2 is preferable. Moreover, the air bubble B being large, that is the volume of the air bubble B being large leads to an increase of a fluid displacement volume in the individual channel 23, and thus leads to an increase of the circulatory flow. For example, following elements can be given as elements that contribute to the increase of the circulatory flow. The elements that contribute to the increase of the circulatory flow include increasing the size of the second energy generation element 24. Moreover, the elements that contribute to the increase of the circulatory flow include increasing the width and the height of the channel on the first supply opening 22 side and reducing the flow resistance R1 relative to the flow resistance R2. Furthermore, the elements that contribute to the increase of the circulatory flow include reducing the viscosity of the ink. Moreover, the elements that contribute to the increase of the circulatory flow include increasing the temperature of the liquid ejection head 1. Furthermore, the elements that contribute to the increase of the circulatory flow include configuring a driving pulse as a double-pulse. Configuring the driving pulse as a double-pulse means as follows. First, a short pulse of such a level that the pulse does not generate an air bubble in a portion of the channel above the second energy generation element 24 is applied to the second energy generation element 24 to heat the ink around the portion of the channel above the second energy generation element 24. Then, a main pulse that generates the air bubble for the circulation of the ink is applied to the second energy generation element 24 to grow a large air bubble.

Moreover, part of the ink made to flow by the circulatory flow of the ink enters an inside of the ejection orifice 11. This causes the concentrated ink in the ejection orifice 11 to be sent out to the channel on the second supply opening 32 side, and causes the fresh ink to flow into the ejection orifice 11 from the channel on the first supply opening 22 side through the individual channel 23. Accordingly, the concentrated ink is less likely to stagnate in the ejection orifice 11. Thus, it is possible to maintain an initial ink ejection state while suppressing effects of the concentrated ink.

The circulatory flow of the ink is a transitional flow generated with the growth process and the contraction process in the case where the air bubble B is generated. Accordingly, after the disappearing of the air bubble B, the inertial circulatory flow of the ink decays over time, and stops after a certain time period. Hence, in order to regularly generate the circulatory flow over a certain time period, the second energy generation element 24 is preferably, repeatedly driven. Note that a driving cycle of the second energy generation element 24 is not limited to a particular cycle, and it is only necessary that the concentrated ink stagnating in the ejection orifice 11 can be discharged. Note that the circulatory flow of the ink is a transitional flow generated with the growth process and the contraction process in the case where the air bubble B is generated. Accordingly, in the case where the second energy generation element 24 is driven at a high driving frequency such as about 100 kHz in consideration of a cycle of 10 μs that is a time period from generation to disappearing of the air bubble B, a phenomenon in which promotion of the circulatory flow of the ink is hindered may occur. Accordingly, it is preferable to drive the second energy generation element 24 at a driving cycle of, for example, about 100 Hz to several tens of kHz.

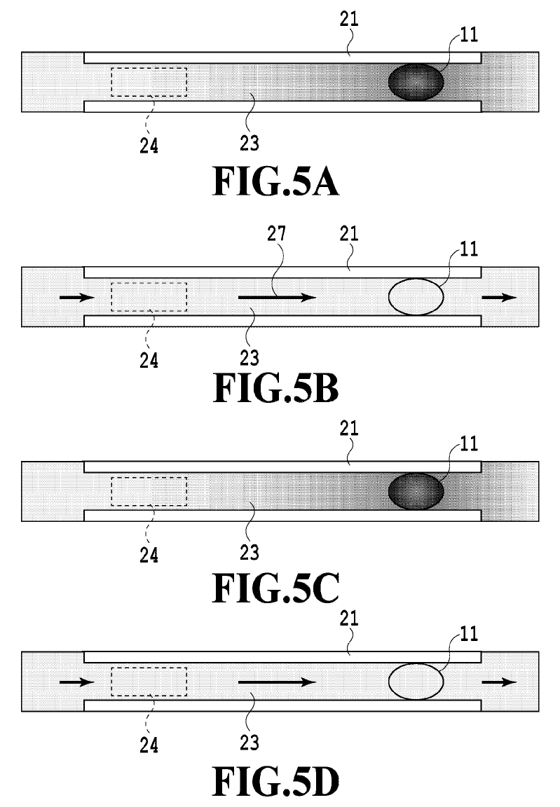

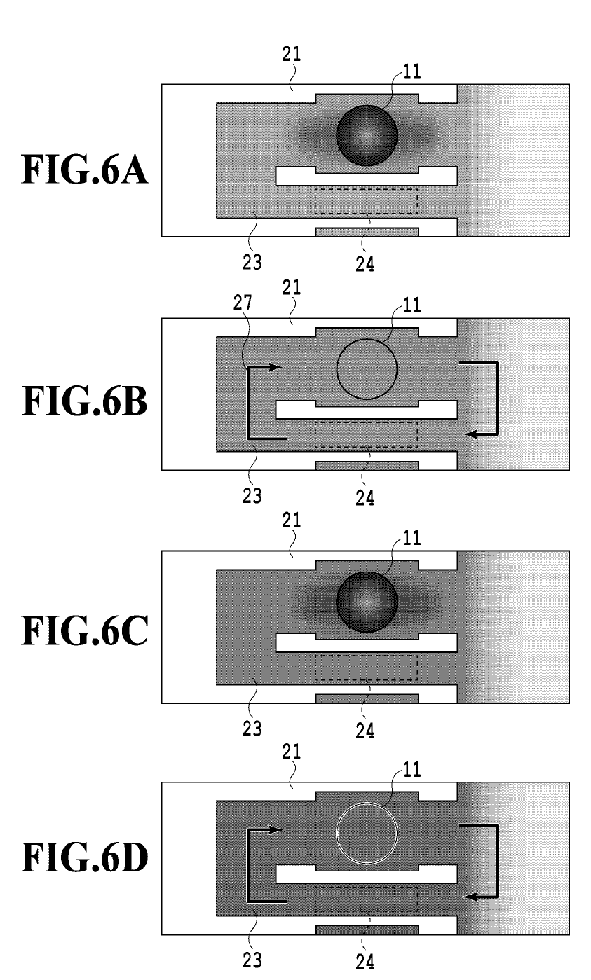

Specifically, the higher the driving frequency of the second energy generation element 24 is, the more the circulatory flow of the ink is maintained. Accordingly, the effect of discharging the concentrated ink attributable to the circulation amount of the ink increases. However, it is assumed that the higher the driving frequency of the second energy generation element 24 is, the more the temperature increase of the ink caused by the heat generation of the second energy generation element 24 attributable to the drive of the second energy generation element 24 is. Accordingly, it is preferable to appropriately control the number of driving times the second energy generation element 24. Next, elimination of an ink concentration increase with the circulatory flow of the ink is explained by using FIGS. 5A to 5D and 6A to 6D.

### Elimination of Ink Concentration Increase; Straight Type

FIGS. 5A to 5D are diagrams explaining how the concentration increase is eliminated with the circulatory flow of the ink in the straight type individual channel 23. FIG. 5A is a diagram illustrating a state where the circulatory flow of the ink is temporarily paused. FIG. 5B is a diagram illustrating a state immediately after generation of the circulatory flow of the ink performed by driving the second energy generation element 24 after the state of FIG. 5A. FIG. 5C is a diagram illustrating a state where the circulatory flow of the ink is temporarily paused after the state of FIG. 5B. FIG. 5D is a diagram illustrating a state immediately after generation of the circulatory flow of the ink performed by driving the second energy generation element 24 after the state of FIG. 5C. As illustrated in FIGS. 5A to 5D, the straight type individual channel 23 has a configuration in which the entrance and the exit of the circulatory flow of the ink are separated from each other. Note that the ink in the individual channel 23 is hatched in a dot pattern, and the density of the dot pattern hatching is increased in a portion where the ink is concentrated to express a level of the ink concentration increase.

As illustrated in FIG. 5A, in the state where the circulatory flow of the ink is temporarily paused, the volatile components of the ink evaporate from the ejection orifice 11. Accordingly, the ink concentration increase progresses near the ejection orifice 11. Then, in the case where the second energy generation element 24 is driven, the circulatory flow of the ink is resumed. As a result, as illustrated in FIG. 5B, the ink concentration increase progressing near the ejection orifice 11 is eliminated. Then, in the case where the circulatory flow of the ink is temporarily paused, as illustrated in FIG. 5C, the ink concentration increase progresses again near the ejection orifice 11 as in FIG. 5A. Thereafter, in the case where the second energy generation element 24 is driven, the circulatory flow of the ink is resumed. As a result, as illustrated in FIG. 5D, the ink concentration increase progressing near the ejection orifice 11 is eliminated as in FIG. 5B. Accordingly, the ink concentration increase is eliminated in the entire individual channel 23. As described above, in the straight type individual channel 23, the ink concentration increase state is reset every time the temporary pausing and the resume of the circulatory flow of the ink are repeated.

<Elimination of Ink Concentration Increase; U-shape Type>

FIGS. 6A to 6D are diagrams explaining how the concentration increase is eliminated with the circulatory flow of the ink in the U-shape type individual channel 23. FIG. 6A is a diagram illustrating a state where the circulatory flow of the ink is temporarily paused. FIG. 6B is a diagram illustrating a state immediately after generation of the circulatory flow of the ink performed by driving the second energy generation element 24 after the state of FIG. 6A. FIG. 6C is a diagram illustrating a state where the circulatory flow of the ink is temporarily paused after the state of FIG. 6B. FIG. 6D is a diagram illustrating a state immediately after generation of the circulatory flow of the ink performed by driving the second energy generation element 24 after the state of FIG. 6C. As illustrated in FIGS. 6A to 6D, the U-shape type individual channel 23 has a configuration in which the entrance and the exit of the circulatory flow of the ink are adjacent to one another. Note that the ink in the individual channel 23 is hatched in a dot pattern, and the density of the dot pattern hatching is increased in a portion where the ink is concentrated to express the level of the ink concentration increase.

As illustrated in FIG. 6A, in the state where the circulatory flow of the ink is temporarily paused, the volatile components of the ink evaporate from the ejection orifice 11. Accordingly, the ink concentration increase progresses near the ejection orifice 11. Then, in the case where the second energy generation element 24 is driven, the circulatory flow of the ink is resumed. As a result, the state illustrated in FIG. 6B is established. The entrance of the individual channel 23 in FIG. 6A and the exit of the individual channel 23 in FIG. 6A are adjacent to each other. Accordingly, the ink concentrated near the ejection orifice 11 is discharged from the exit of the individual channel 23, but part of the discharged ink flows into the individual channel 23 again from the entrance of the individual channel 23. Accordingly, a phenomenon in which the ink in the entire individual channel 23 is not replaced by the fresh ink, and is replaced by slightly concentrated ink (hereinafter, this phenomenon is referred to as recirculation concentration increase) occurs. Then, in the case where the circulatory flow of the ink is temporarily paused, as illustrated in FIG. 6C, the ink concentration increase progresses again near the ejection orifice 11 from the state of FIG. 6B as in FIG. 6A. Thereafter, in the case where the second energy generation element 24 is driven, the circulatory flow of the ink is resumed. As a result, as illustrated in FIG. 6D, the ink in the entire individual channel 23 is replaced by the ink further concentrated from that in FIG. 6B due to the effect of the recirculation concentration increase. As described above, in the U-shape individual channel 23, the ink concentration increase state is not reset every time the temporary pausing of the circulatory flow of the ink and the circulation operation are repeated, and the ink concentration increase gradually progresses in the entire individual channel 23. Moreover, assume a case where the temporary pausing and the resume of the circulatory flow of the ink are not repeated. Also in this case, if a temporary pausing period of the circulatory flow of the ink is long and the ink concentration increase near the ejection orifice 11 progresses, an effect of improving the ink concentration increase state of the ink is less likely to be obtained even in the first resuming of the circulatory flow of the ink. The reason for this is because the effect of improving the ink concentration increase state is small due to the recirculation concentration increase.

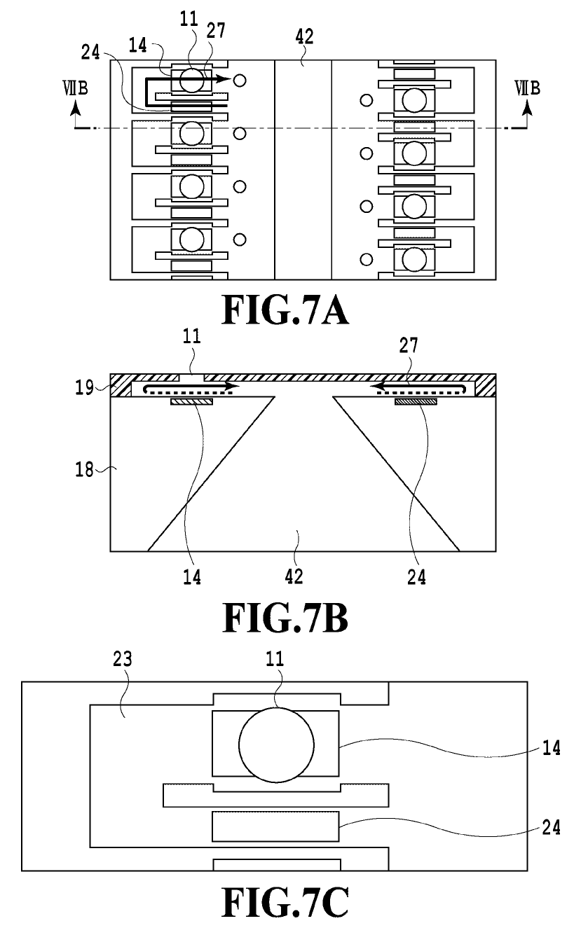

Accordingly, the straight type individual channel 23 and the U-shape type individual channel 23 differ from each other in the effect of the discharged concentrated ink, and this causes a difference in the effect of eliminating the ink concentration increase state by the temporary pausing and the resume of the circulatory flow of the ink. Specifically, in the case of the straight type individual channel 23, the ink concentration increase state including the entire individual channel 23 is more likely to be eliminated. Meanwhile, in the case of the U-shape type individual channel 23, the ink concentration increase state including the entire individual channel 23 is less likely to be eliminated due to the recirculation concentration increase. Accordingly, in the case of the U-shape type individual channel 23, the ejection of the ink may become unstable depending on a degree of concentration increase in the entire individual channel 23. Next, a configuration of a portion of the U-shape type individual channel 23 near the ejection orifice 11 is explained by using FIGS. 7A to 7C.

### Configuration of Portion of U-shape Type Individual Channel 23 near Ejection Orifice 11

FIGS. 7A to 7C are diagrams explaining the portion of the U-shape type individual channel near the ejection orifice 11 in detail. FIG. 7A is a plan diagram as viewed in the direction in which the liquid droplet is ejected from the ejection orifice 11. FIG. 7B is a VIIB-VIIB cross-sectional diagram of FIG. 7A. FIG. 7C is an enlarged schematic diagram of the individual channel 23 in FIG. 7A.

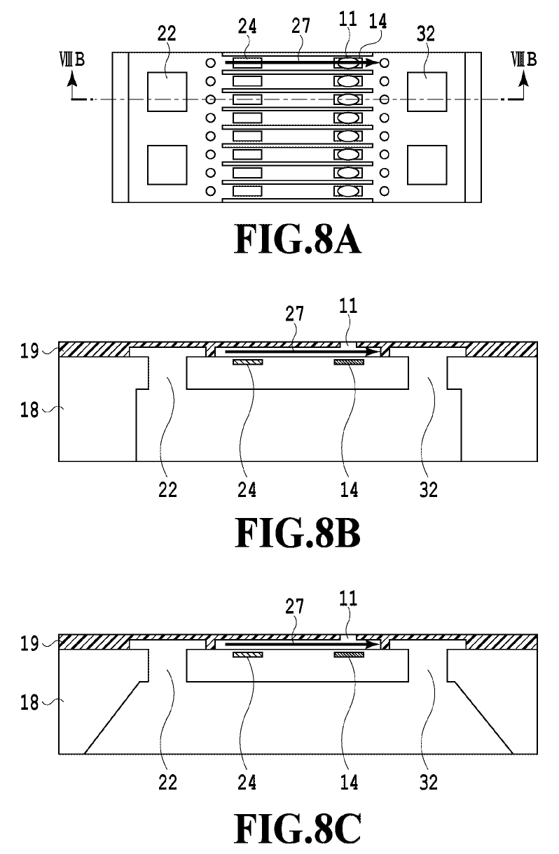

In FIGS. 7A and 7B, each of the ejection orifices 11 is an opening portion formed in a portion of the orifice plate 19. In the substrate 18, the first energy generation element 14 is formed at a position directly below and corresponding to each ejection orifice 11. The second energy generation element 24 is also formed in the substrate 18. The second energy generation element 24 generates the circulatory flow of the ink in the direction illustrated by the arrow 27 in the channel including the individual channels 23. A supply groove 42 is formed in the direction along the arrays of the ejection orifices 11, between the arrays of the first energy generation elements 14 and the arrays of the second energy generation elements 24 in the substrate 18 to penetrate substrate 18. The supply groove 42 communicates with the individual channels 23, and can supply the ink to the individual channels 23. As described above, the configuration is not limited to the configuration provided with multiple independent supply openings like the first supply openings 22 and the second supply openings 32 in FIGS. 3A to 3D, and the liquid may be made to flow in and out by using a large opening like the common supply groove 42 in FIGS. 7A to 7C. Next, a configuration of a portion of the straight type individual channel 23 near the ejection orifice 11 is explained by using FIGS. 8A to 8C.

### Configuration of Portion of Straight Type Individual Channel 23near Ejection Orifice 11

FIGS. 8A to 8C are diagrams explaining the portion of the straight type individual channel 23 near the ejection orifice 11 in detail. FIG. 8A is a plan diagram as viewed in the direction in which the liquid droplet is ejected from the ejection orifice 11. FIG. 8B is a VIIIB-VIIIB cross-sectional diagram of FIG. 8A. FIG. 8C is a VIIIB-VIIIB cross-sectional diagram of FIG. 8A, and is a cross-sectional diagram in which the configuration inside the substrate 18 is different from that in FIG. 8B. FIGS. 8B and 8C illustrate two examples that differ from each other in the shape of the back side of the substrate 18 depending on a type of etching method applied to the substrate 18, and the shape of the back side of the substrate 18 may be either shape. In other words, the configuration inside the substrate 18 may be any configuration.

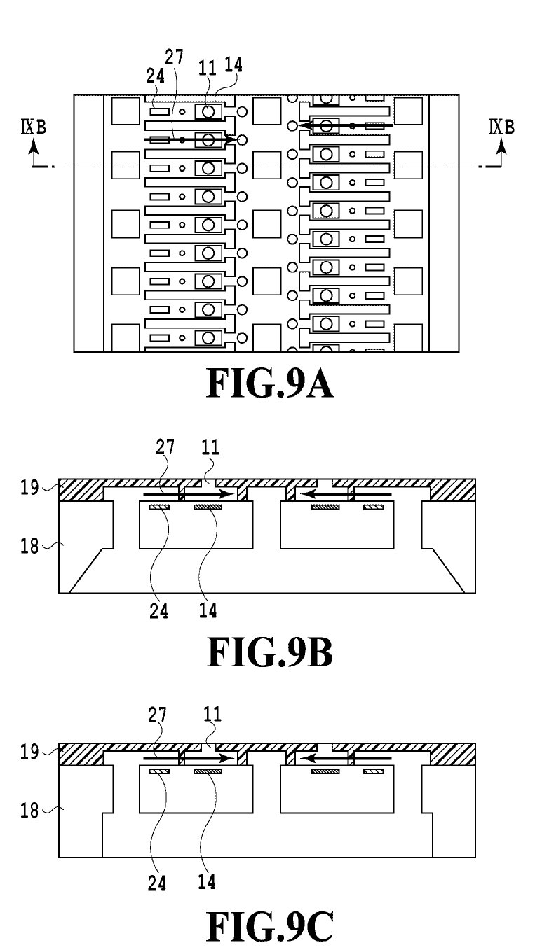

The present configuration is different from the configuration of the portion of the U-shape type individual channel 23 near the ejection orifice 11 in that the individual channel 23 has the straight type configuration in which the entrance and the exit of the individual channel 23 are not adjacent to each other as in the U-shape type individual channel 23, and are separated from each other. Moreover, the direction connecting both ends of the straight type individual channel 23 is orthogonal to the direction in which the ejection orifices 11 are arranged to form an array as illustrated in FIG. 8A. Adopting such an arrangement configuration causes the position where the circulatory flow of the ink flows into the individual channel 23 and the position where the circulatory flow of the ink flows out from the individual channel 23 to be separated from each other. Accordingly, it is possible to suppress the concentrated ink in the ejection orifice 11 from flowing into the individual channel 23 again. The effect of the ink concentration increase can be thereby suppressed. Next, another configuration of the portion of the straight type individual channel 23 near the ejection orifice 11 is explained by using FIGS. 9A to 9C.

### Another Configuration of Portion of Straight Type Individual Channel 23 near Ejection Orifice 11

FIGS. 9A to 9C are other schematic diagrams explaining the portion of the straight type individual channel 23 near the ejection orifice. FIG. 9A is a plan diagram as viewed in the direction in which the liquid droplet is ejected from the ejection orifice 11. FIG. 9B is a IXB-IXB cross-sectional diagram of FIG. 9A. FIG. 9C is a IXB-IXB cross-sectional diagram of FIG. 9A, and is a cross-sectional diagram in which the configuration inside the substrate 18 is different from that in FIG. 9B. FIGS. 9B and 9C illustrate two examples that differ from each other in the shape of the back side of the substrate 18 depending on the type of etching method applied to the substrate 18, and the shape of the back side of the substrate 18 may be either shape. Specifically, the configuration inside the substrate 18 may be any configuration. Moreover, the present configuration is different from that in FIG. 8A in that the number of ink supply opening arrays is increased by one from two to three. The number of arrays of the ejection orifices 11 can be thereby doubled, and the arrays of the ejection orifices 11 can be arranged on the sides close to the center ink supply openings. Specifically, the arrays of the ejection orifices 11 are arranged in the array direction of the multiple ink supply openings at the center, on both sides of the multiple ink supply openings. This arrangement can increase the number of the ink supply opening arrays by one from two to three, and double the number of arrays of the ejection orifices 11 from one to two. Moreover, as illustrated in FIG. 9A, the two arrays of the ejection orifices 11 can be arranged with pitches of the respective two arrays of the ejection orifices 11 shifted from each other. Furthermore, it is possible not to include wiring regions between the supply openings in the center ink supply opening array. Accordingly, this configuration has high degrees of freedom in terms of resolution and the size of the openings in the center ink supply opening array. This configuration enables quick refill into the ejection orifices 11, and can handle high productivity. Note that the positions of the ejection orifices 11 and the positions of the ink supply openings can be shifted to suit routing of wiring lines. Next, the ink according to the present embodiment is explained.

### Ink

As explained above, although the level of eliminating the ink concentration increase differs based on the difference in the configuration of the channel including the individual channel 23, the following effects can be provided by generating the circulatory flow of the ink in the individual channel 23 with the second energy generation element 24. Specifically, the effects of the concentrated ink thickened due to evaporation of the volatile components in the ink in the ejection orifice 11 can be suppressed. Accordingly, the ejection state of the ink can be maintained at an excellent level, and effects of a change in ink ejection speed can be further reduced. Thus, ejection of the ink can be stabilized.

Meanwhile, use of an ink with a different type of ink color material, a different content amount of ink solid contents, and the like is conceivable depending on the application of the liquid ejection head 1 or the liquid ejection apparatus 50 in which the liquid ejection head 1 is mounted. Specifically, performance of the liquid ejection head 1 is preferably such that the liquid ejection head 1 can maintain ink ejection stability regardless of the type of used ink.

For example, as a case resulting from water in the ink, there is a case where changes such as curling (also referred to as warping) and cockling (also referred to as corrugating wrinkles) may occur in a plain paper. In such a case, use of an ink with a reduced water amount is conceivable. Moreover, in an ink with a low water amount, concentrations of an organic solvent other than water and the solid contents of the ink such as pigment and resin are high. Accordingly, the viscosity of the ink tends to rapidly increase with evaporation of water in the ink. Hence, the ink with low water amount tends to cause a decrease of ink ejection stability. In view of this, in the case where the ink with low water amount is used, an increase in the viscosity of the ink can be suppressed by generating the circulatory flow of the ink in the channel configuration including the individual channel 23 as in the present embodiment. Generally, an ink with a large amount of solid contents has 10 wt% of solid contents. Specifically, the present embodiment is preferably applied to an ink in which a content amount of solid contents contained in the ink is 10 wt% (also referred to as mass%) or more.

A relationship between an operation temperature of the liquid ejection head 1 and the viscosity of the ink is explained. There is a case where the second energy generation elements 24 arranged in the entire liquid ejection chip 3 are driven and controlled to heat the liquid ejection head 1 until the temperature of the liquid ejection head 1 reaches a certain temperature, and the liquid ejection head 1 is used. The viscosity of the ink changes depending on the temperature of the ink. Accordingly, the viscosity of the ink at the operation temperature of the liquid ejection head 1 affects the ejection stability of the ink.

A relationship between a circulatory flow rate of the ink and a driving frequency of each of the first energy generation elements 14 and the second energy generation elements 24 is explained. In the case where the circulatory flow of the ink is generated by the second energy generation elements 24, it is possible to achieve a circulatory flow rate in which an instant flow rate of the ink is several tens of mm/s to 1,000 mm/s. An average flow rate as viewed in a time width in the order of several hundred μs depends on the driving frequency of the second energy generation elements 24. The reason for this is as follows. In the case where the circulatory flow of the ink is generated by the second energy generation elements 24, the circulatory flow of the ink is a transitional circulatory flow that decays over time and stops after a certain time period. Meanwhile, in the case where the circulatory flow of the ink is generated by the first energy generation elements 14, drive at a frequency of about 10 to 20 kHz that is about the same level as the driving frequency (also referred to as ejection frequency) of the first energy generation elements 14 is possible. In this case, the average flow rate of the circulatory flow of the ink can be several mm/s to 100 mm/s. Next, a relationship between a pigment concentration and the elimination of the ink concentration increase is explained.

### INK WITH HIGH PIGMENT CONCENTRATION

A case of an ink with a high pigment concentration is explained. For example, in the case where an ink with such a concentration that the viscosity of the ink at the operation temperature of the liquid ejection head 1 is 3 cP or more and 6 cP or less is used, thickening of the ink tends to progress near the ejection orifices 11 depending on a non-ejection time period of the ink (also referred to as paused time period of the circulatory flow of the ink). Accordingly, a change in the ink ejection speed tends to occur. Hence, a decrease in the ink ejection stability tends to occur. In order to suppress the decrease of the ink ejection stability, it is preferable to generate a certain circulation amount of the ink while the paused time period of the circulatory flow of the ink is short and circulate the ink. Accordingly, performing regular circulation of the ink or performing transitional circulation of the ink at high frequency is preferable to eliminate the concentration increase of the ink. The transitional circulation of the ink can be performed by driving the second energy generation elements 24. Driving the second energy generation elements 24 and resuming the circulatory flow of the ink at high frequency from the paused state of the circulatory flow of the ink can contribute to elimination of the concentration increase of the ink near the ejection orifices 11.

### Ink with Low Pigment Concentration

A case of an ink with a low pigment concentration is explained. For example, in the case where an ink with such a concentration that the viscosity of the ink at the operation temperature of the liquid ejection head 1 is 1 cP or more and 2 cP or less is used, thickening of the ink may progress near the ejection orifices 11 depending on the non-ejection time period of the ink (also referred to as paused time period of the circulatory flow of the ink). Accordingly, a change in the ink ejection speed may occur, but is smaller than that in the high-concentration ink. Meanwhile, in the case where the paused time period of the circulatory flow of the ink is long, for example, the thickening of the ink near the ejection orifices 11 may progress depending on a non-print drive time period (also referred to as stopped time period). Accordingly, in the case where the liquid ejection head 1 is stopped without performing printing for a certain time period and then made to restart, it is preferable to execute a recovery process involving waste ink such as a suction operation of the ink, a wipe operation, or preliminary ejection in which these operations are combined. Performing drive of the second energy generation elements 24 to resume the circulatory flow of the ink as the recovery operation can contribute to elimination of the ink concentration increase near the ejection orifices 11 without generation of the waste ink. Moreover, it is possible to avoid generation of the waste ink by driving the second energy generation elements 24 and performing a recovery process enough to resume the circulatory flow of the ink depending on the stop time period. Alternatively, it is possible to perform a recovery process in which the waste ink is minimized by combining a suction operation for removing the air bubble B in the liquid ejection head 1 separate from the elimination of the ink concentration increase while resuming and recovering the circulatory flow of the ink.

### More Appropriate Configuration for Elimination of Ink Concentration Increase

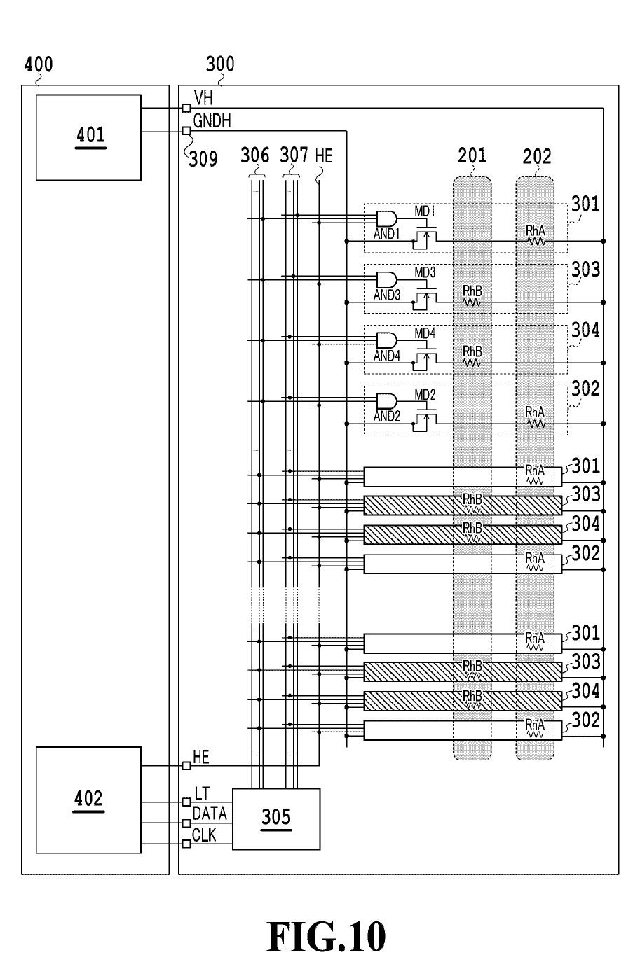

As explained above, in order suppress the effects of the concentrated ink, it is preferable to replace the concentrated ink to the initial fresh ink as much as possible for both of the high-concentration ink and the low-concentration ink. Accordingly, in the case where the second energy generation elements 24 are driven, the lower the effect of the recirculation concentration increase is, the higher the obtained circulation effect is. Specifically, a higher circulation effect can be obtained in the configuration of the straight type individual channel 23 than in the configuration of the U-shape type individual channel 23. Next, an electric circuit configuration that drives and controls the first energy generation elements 14 and the second energy generation elements 24 according to the present embodiment is explained by using FIGS. 10 to 20.

### Heater Selection Circuit

FIG. 10 is a diagram illustrating a circuit configuration example of a print element substrate 300 according to the present embodiment. Various signals are supplied from a main PCB 400 to the print element substrate 300. The main PCB 400 includes a power circuit 401 and a controller 402. The power circuit 401 applies a power supply voltage to the print element substrate 300 via a power supply line VH. The power circuit 401 and the print element substrate 300 are connected to each other via a ground line GNDH. The ground line GNDH is included in a ground wiring layer. A reference potential of the print element substrate 300 is set by the ground wiring layer. Accordingly, the ground line GNDH functions as the reference potential of the print element substrate 300. The controller 402 is formed mainly of a ROM, a RAM, and a CPU, and supplies various electric signals to the print element substrate 300. The controller 402 is connected to the print element substrate 300 via an enable signal line HE, a latch signal line LT, a data signal line DATA, and a clock signal line CLK. The controller 402 supplies an enable signal via the enable signal line HE. The enable signal is a signal that controls a time period in which an element to be controlled is set to an on state and a current flows to the element, based on a pulse width. The enable signal is a signal for performing adjustment such that more desirable thermal energy generation can be performed by taking into consideration manufacturing errors of heater resistance values in the print element substrate 300, manufacturing errors of the power circuit 401, and voltage drop of power supply wiring lines that occurs in the case where multiple heaters are simultaneously driven. In the present embodiment, explanation is given of an example in which the enable signal line HE is shared between ejection and circulation to reduce the number of signal terminals. However, providing individual enable signal lines HE for ejection and circulation allows different pulse widths to be set for ejection and circulation. Note that, in the case where the enable signal line HE is shared between ejection and circulation as in the present embodiment, the configuration is preferably as follows. Specifically, it is preferable that ejection heaters RhA and circulation heaters RhB are formed in an identical step of a semiconductor manufacturing process, and the pulse width of the enable signal is adjusted assuming that the heaters have the same manufacturing errors (same resistance value deviation amount with respect to an ideal value). The controller 402 supplies a latch signal to the print element substrate 300 via the latch signal line LT. The controller 402 supplies a data signal to the print element substrate 300 via the data signal line DATA. The controller 402 supplies a clock signal to the print element substrate 300 via the clock signal line CLK.

The print element substrate 300 includes ejection modules 301 and 302 and circulation modules 303 and 304. The ejection modules 301 and 302 include the ejection heaters RhA, ejection drive elements MD1 and MD2, and ejection logic circuits AND1 and AND2. The ejection heaters RhA are the ejection energy generation elements. The first energy generation elements 14 are also the ejection energy generation elements. In other words, the ejection heaters RhA and the first energy generation elements 14 refer to the same elements. These terms are selectively used depending on whether the elements are circuit elements or elements arranged in the structure of the individual channels 23. The ejection drive elements MD1 and MD2 are elements for causing currents to flow in the ejection heaters RhA. The ejection logic circuits AND1 and AND2 are elements for selectively driving the ejection drive elements MD1 and MD2. The print element substrate 300 generates heat by causing the currents to flow in the ejection heaters RhA. The ink is thereby made to bubble and is ejected, and this allows printing to be performed on the ejection target medium P.

The circulation modules 303 and 304 include the circulation heaters RhB, circulation drive elements MD3 and MD4, and circulation logic circuits AND3 and AND4. The circulation heaters RhB are the circulation energy generation elements. The second energy generation elements 24 are also the circulation energy generation elements. In other words, the circulation heaters RhB and the second energy generation elements 24 refer to the same elements. These terms are selectively used depending on whether the elements are the circuit elements or the elements arranged in the structure of the individual channels 23. The circulation drive elements MD3 and MD4 are elements for causing currents to flow in the circulation heaters RhB. The circulation logic circuits AND3 and AND4 are elements for selectively driving the circulation drive elements MD3 and MD4. The print element substrate 300 generates heat by causing the currents to flow in the circulation heaters RhB. The air bubble B in the ink thereby grows, and the circulatory flow can be generated in the channel of the ink including the individual channels 23.

Note that, in the ejection heaters RhA, piezoelectric elements may be used as elements for ejecting the ink. In the circulation heaters RhB, piezoelectric elements may be used as elements for circulating the ink. Each of the ejection drive elements MD1 and MD2 and the circulation drive elements MD3 and MD4 is an N-type high-voltage tolerant transistor. Thus, each of the ejection drive elements MD1 and MD2 and the circulation drive elements MD3 and MD4 is a transistor with a higher voltage tolerance than a transistor used in a logic circuit. The high-voltage tolerant transistor is preferably formed such that it does not fail even in a case where a voltage (for example, 32 V) too high for a transistor in a general logic circuit forming a control unit to tolerate is applied.

The print element substrate 300 includes a control data supply circuit 305. A group selection signal line 306, a time division selection signal line 307, and the enable signal line HE are provided in the print element substrate 300. The control data supply circuit 305 is electrically connected to each of the group selection signal line 306, the time division selection signal line 307, and the enable signal line HE. Each of the group selection signal line 306, the time division selection signal line 307, and the enable signal line HE is electrically connected to the ejection modules 301 and 302 and the circulation modules 303 and 304. Accordingly, the control data supply circuit 305 can exchange various signals with the ejection modules 301 and 302 and the circulation modules 303 and 304 via the group selection signal line 306 and the time division selection signal line 307.

Specifically, each of the group selection signal line 306, the time division selection signal line 307, and the enable signal line HE is connected to the input sides of the ejection logic circuits AND1 and AND2. The output sides of the ejection logic circuits AND1 and the ejection drive elements MD1 are connected to one another. The output sides of the ejection logic circuits AND2 and the ejection drive elements MD2 are connected to one another. Accordingly, the ejection drive elements MD1 are selected and controlled such that the ejection drive elements MD1 go into a conductive state depending on outputs of the ejection logic circuits AND1, and the currents flow in the ejection heaters RhA. Similarly, the ejection drive elements MD2 are selected and controlled such that the ejection drive elements MD2 go into a conductive state depending on outputs of the ejection logic circuits AND2, and the currents flow in the ejection heaters RhA. Moreover, the circulation drive elements MD3 are selected and controlled such that the circulation drive elements MD3 go into a conductive state depending on outputs of the circulation logic circuits AND3, and the currents flow in the circulation heaters RhB. Similarly, the circulation drive elements MD4 are selected and controlled such that the circulation drive elements MD4 go into a conductive state depending on outputs of the circulation logic circuits AND4, and the currents flow in the circulation heaters RhB.

Although not illustrated, the control data supply circuit 305 includes a shift register and a latch circuit. In the shift register, a time division selection signal is transferred as serial data depending on a clock signal. The latch circuit holds the time division selection signal depending on a latch signal.

### First Case

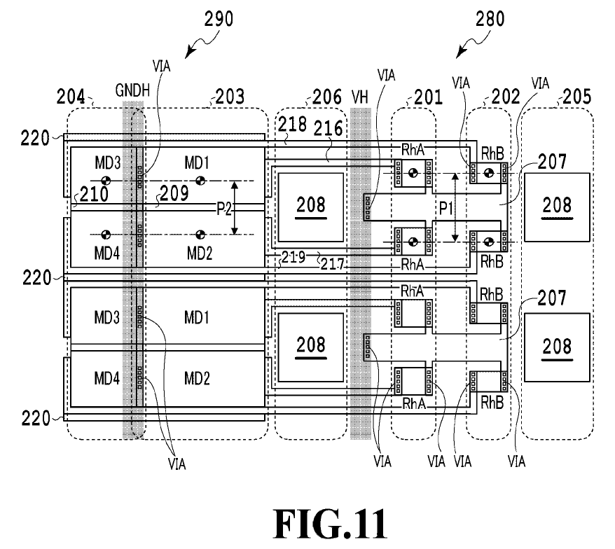

FIG. 11 is a diagram illustrating an arrangement example of heaters and drive elements in a first case according to the present embodiment. In FIG. 11, the ejection heaters RhA and the circulation heaters RhB are arranged on the print element substrate 300 as the heaters. Moreover, in FIG. 11, the ejection drive elements MD1 and MD2 and the circulation drive elements MD3 and MD4 are arranged on the print element substrate 300 as the drive elements. Furthermore, in FIG. 11, drain wiring lines 216, 217, 218, and 219 are arranged in the print element substrate 300. Note that, in the following explanation, each of the ejection drive elements MD1 and MD2 is assumed to be formed of a metal-oxide-semiconductor field effect transistor (MOSFET). Moreover, in the following explanation, each of the circulation drive elements MD3 and MD4 is assumed to be formed of a metal-oxide-semiconductor field effect transistor (MOSFET). Note that each of the ejection drive elements MD1 and MD2 and the circulation drive elements MD3 and MD4 may be formed of an element other than the MOSFET. For example, each of the ejection drive elements MD1 and MD2 and the circulation drive elements MD3 and MD4 may be formed of a bipolar transistor. Alternatively, each of the ejection drive elements MD1 and MD2 and the circulation drive elements MD3 and MD4 may be formed of an insulated gate bipolar transistor (IGBT).

Specifically, in the example of FIG. 11, supply orifice arrays 205 and 206, an ejection heater array 201, a circulation heater array 202, an ejection drive element array 203, and a circulation drive element array 204 are arranged on the print element substrate 300. In the present embodiment, the circulation heater array 202 is arranged on the left side of and in parallel with the supply orifice array 205. The ejection heater array 201 is arranged on the left side of and in parallel with the circulation heater array 202. The supply orifice array 206 is arranged on the left side of and in parallel with the ejection heater array 201. The ejection drive element array 203 is arranged on the left side of and in parallel with the supply orifice array 206. The circulation drive element array 204 is arranged on the left side of and in parallel with the ejection drive element array 203. Vias VIA are provided between the ejection heater array 201 and the supply orifice array 206. The vias VIA between the ejection heater array 201 and the supply orifice array 206 are electrically connected to the power supply line VH in another wiring layer. Vias VIA are provided between the ejection drive element array 203 and the circulation drive element array 204. The vias VIA between the ejection drive element array 203 and the circulation drive element array 204 are electrically connected to the ground line GNDH in the other wiring layer.

Multiple ejection heaters RhA are arranged in an array in the ejection heater array 201. An arrangement density of the ejection heaters RhA is, for example, 600 dpi. Multiple circulation heaters RhB are arranged in an array in the circulation heater array 202. Each of the circulation heaters RhB are arranged adjacent to a corresponding one of the ejection heaters RhA to form a pair. Multiple units in each of which the ejection drive element MD1 and the ejection drive element MD2 are arranged adjacent to each other in an array direction are arranged in the ejection drive element array 203. A shared ground electrode 209 is arranged in each unit as an electrode shared by the ejection drive element MD1 and the ejection drive element MD2 adjacent to the ejection drive element MD1. The shared ground electrode 209 is electrically connected to the ground line GNDH in the other wiring layer via the vias VIA. Multiple units in each of which the circulation drive element MD3 and the circulation drive element MD4 are arranged adjacent to each other in the array direction are arranged in the circulation drive element array 204. A shared ground electrode 210 is arranged in each unit as an electrode shared by the circulation drive element MD3 and the circulation drive element MD4 adjacent to the circulation drive element MD3. The shared ground electrode 210 is electrically connected to the ground line GNDH in the other wiring layer via the vias VIA, like the shared ground electrode 209.

A distance P2 between the centers of gravity of the ejection drive element MD1 and the ejection drive element MD2 in each unit is smaller than a distance P1 between the centers of gravity of the respective adjacent ejection heaters RhA. The distance P2 between the centers of gravity of the ejection drive element MD1 and the ejection drive element MD2 in each unit is smaller than a distance P1 between the centers of gravity of the respective adjacent circulation heaters RhB. For example, in the case where the ejection heaters RhA are arranged at 600 dpi, the distance P1 is 42.3 μm. Meanwhile, the distance P2 is about 32 μm with the shared ground electrode 209 included in each unit. Accordingly, there is an extra space of about 10 μm. A substrate contact 220 can be arranged between the ejection drive element MD1 and the ejection drive element MD2 in the respective adjacent units by utilizing this extra space. Similarly, the substrate contact 220 can be arranged also between the circulation drive element MD3 and the circulation drive element MD4 in the respective adjacent units by utilizing this extra space. Moreover, the drain wiring lines 218 and 219 can be passed by utilizing this extra space. In this example, the centers of gravity each means the center with respect to an element region including a lead out portion of an electrode necessary for drive. In the present embodiment, the current in the circulation heaters RhB is assumed to be smaller than the current in the ejection heaters RhA. In the example of FIG. 11, the circulation drive elements MD3 and MD4 are smaller in an array width direction than the ejection drive elements MD1 and MD2, and have a smaller element area. In this example, the array width direction is assumed to be a lateral direction in an identical array among lateral directions orthogonal to the array (also referred to as vertical) direction.

Next, an arrangement relationship of the ejection drive elements MD1 and MD2 and the circulation drive elements MD3 and MD4 from a perspective in the lateral direction is explained. Each of the ejection drive elements MD1 and a corresponding one of the circulation drive elements MD3 are arranged adjacent to each other in the lateral direction to form a pair. Similarly, each of the ejection drive elements MD2 and a corresponding one of the circulation drive elements MD4 are arranged adjacent to each other in the lateral direction to form a pair. In a case where the ejection drive element MD1 and the circulation drive element MD3 are grouped into one unit along the lateral direction, the shared ground electrode is shared in each unit. The shared ground electrode shared by the ejection drive element MD1 and the circulation drive element MD3 in each unit is connected to the ground line GNDH in the other wiring layer via the vias VIA. Sharing the shared ground electrode as described above can reduce a region necessary for connection to the ground line GNDH. Although the vias VIA are arranged in an array in the present embodiment, the arrangement is not limited particularly to this arrangement. For example, the vias VIA may be arranged in multiple arrays depending on a density of a current flowing through the vias VIA.

Moreover, in a case where each of the ejection drive elements MD2 and a corresponding one of the circulation drive elements MD4 are grouped into one unit, the shared ground electrode is shared in each unit. The shared ground electrode shared by the ejection drive element MD2 and the circulation drive element MD4 in each unit is connected to the ground line GNDH in the other wiring layer via the vias VIA. Sharing the shared ground electrode as described above can reduce the region necessary for connection to the ground line GNDH. In other words, the ejection drive elements MD1 and MD2 and the circulation drive elements MD3 and MD4 in two segments can share the electrode electrically connected to the ground line GNDH in a cross shape in a region being boundaries. Moreover, the ejection drive elements MD1 and MD2 that require a larger driving current than the circulation drive elements MDb and MD4 are arranged closer to a heating element region 280 including the ejection heaters RhA and the circulation heaters RhB than the circulation drive elements MD3 and MD4 are. Such an arrangement configuration can suppress resistances of wiring lines to the heating element region and achieve higher drive efficiency. Moreover, although the supply orifice array 206 is provided in the present embodiment, the supply orifice array 206 does not have to be provided. Furthermore, although independent supply orifices 208 are provided in the supply orifice array 205 in the present embodiment, the supply orifices do not have to be independent, and a configuration of one long supply orifice extending along the array direction may be adopted. Note that the heating element region 280 is a region in which the heating resistance elements are arranged in the same layer in the print element substrate 300. In the present embodiment, at least one of the ejection heaters RhA and the circulation heaters RhB are used as the heating resistance elements. Accordingly, the heating element region 280 is a region in which at least one of the ejection heaters RhA and the circulation heaters RhB are arranged in the print element substrate 300. For example, a region including the ejection heater array 201 and the circulation heater array 202 on the same layer in the print element substrate 300 is the heating element region 280. Specifically, multiple ejection heaters RhA formed as the ejection heater array 201 are arranged in a first region of the heating element region 280. Moreover, multiple circulation heaters RhB formed as the circulation heater array 202 are arranged in a second region of the heating element region 280. Note that, in the case where other heating resistance elements are arranged, the other heating resistance elements may be arranged in a third region of the heating element region 280.

### Second Case

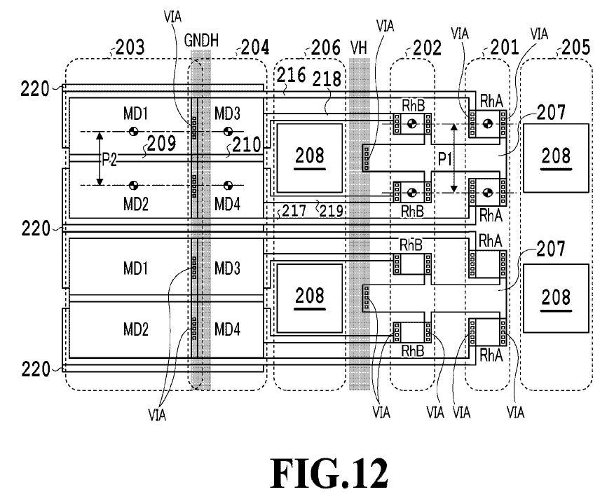

FIG. 12 is a diagram illustrating an arrangement example of the heaters and the drive elements in a second case according to the present embodiment. A difference from FIG. 11 that is the first case is such that a positional relationship between the ejection heater array 201 and the circulation heater array 202 is reversed. Specifically, the circulation heater array 202 is arranged on the drive element region 290 side with respect to the ejection heater array 201, the drive element region 290 including the ejection drive elements MD1 and MD2 and the circulation drive elements MD3 and MD4. Accordingly, the arrangement of the ejection drive element array 203 and the circulation drive element array 204 also differs from that in the first case. Specifically, the circulation drive element array 204 is arranged on the side close to the heating element region with respect to the ejection drive element array 203. Such an arrangement configuration allows the substrate contact 220 to be arranged between the ejection drive element MD1 and the ejection drive element MD2 in the respective adjacent units by utilizing the extra space as in the first case. Moreover, the substrate contact 220 can be arranged between the circulation drive element MD3 and the circulation drive element MD4 in the respective adjacent units by utilizing this extra space. Furthermore, the drain wiring lines 218 and 219 can be passed by utilizing this extra space. Specifically, the conductive layer and the wiring layer can be routed in the same layer in the drive element region 290. Note that the drive element region 290 is a region in which the drive elements are arranged on the same layer in the print element substrate 300. In the present embodiment, at least one of the ejection drive elements MD1 and MD2 and the circulation drive elements MD3 and MD4 are used as the drive elements. Accordingly, the drive element region 290 is a region in which at least one of the ejection drive elements MD1 and MD2 and the circulation drive elements MD3 and MD4 are arranged in the print element substrate 300. For example, a region including the ejection drive element array 203 and the circulation drive element array 204 on the same layer in the print element substrate 300 is the drive element region 290. Specifically, the ejection drive elements MD1 and MD2 formed as the ejection drive element array 203 are arranged in a first region of the drive element region 290 unit by unit. Moreover, the circulation drive elements MD3 and MD4 formed as the circulation drive element array 204 are arranged in a second region of the drive element region 290 unit by unit. Note that, in the case where other drive elements are arranged, the other drive elements may be arranged in a third region of the drive element region 290.

### First Comparative Example

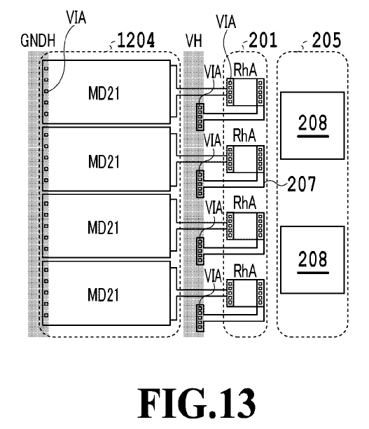

FIG. 13 is a diagram illustrating an arrangement example of the heaters and the drive elements in a first comparative example. FIG. 13 illustrates an example in which the ejection heaters RhA are arranged and no circulation heaters RhB are arranged. The ejection heaters RhA are arranged at an arrangement density of 600 dpi, and form the ejection heater array 201. Ejection drive elements MD21 are arranged as many as the ejection heaters RhA at an arrangement density of 600 dpi, and form an ejection drive element array 1204. The ejection drive element array 1204 is arranged parallel to the ejection heater array 201.

### Second Comparative Example

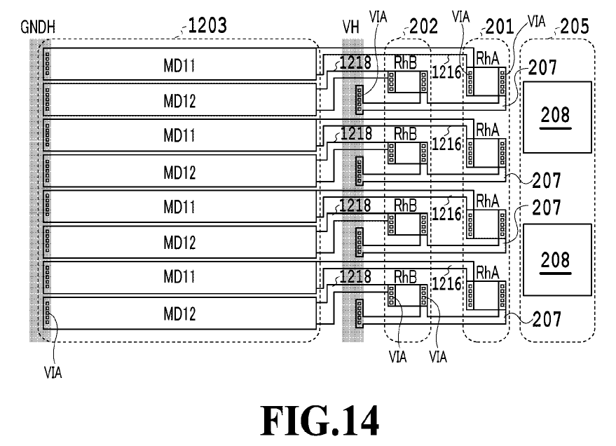

FIG. 14 is a diagram illustrating an arrangement example of the heaters and the drive elements in a second comparative example. The ejection heaters RhA are arranged at an arrangement density of 600 dpi, and form the ejection heater array 201. The circulation heaters RhB are arranged at the same arrangement density as the ejection heaters RhA, and form the circulation heater array 202. The ejection heaters RhA are electrically connected to ejection drive elements MD11 via a wiring layer 1216. The circulation heaters RhB are electrically connected to circulation drive elements MD12 via a wiring layer 1218. In the case where the print element substrate 300 is formed in a lower-cost manufacturing process, additionally providing electric connection wiring layers in a layer separate from conductive layers for leading out electrodes of the ejection drive elements MD11 and the circulation drive elements MD12 is not preferable. Specifically, the conductive layers in the ejection drive elements MD11 and the circulation drive elements MD12 and the wiring layers 1216 and 1218 are preferably formed in the same layer, in the same manufacturing step. In an example of FIG. 14, multiple ejection drive elements MD11 and multiple circulation drive elements MD12 are arranged as a unit to form a drive element array 1203. In the drive element array 1203, the drive elements are arranged at 1,200 dpi that is twice the arrangement density of the ejection heaters RhA. In such an arrangement configuration, the wiring layer 1216 can be routed in the same layer as the wiring layer 1218. However, in the second comparative example, the number of drive elements arranged in the array length direction is double of that in the first comparative example. Accordingly, the dimension of each drive element in the array length direction is 1/2 of that in the first comparative example. Thus, FIG. 14 illustrates an example in which the ejection drive elements MD11 are designed to have the same drive element area as that in the first comparative example by doubling the dimension in the array width direction to secure drive performance high enough to allow the same driving current as that in the first comparative example to flow in the ejection drive elements MD11.

Meanwhile, the driving current of the circulation heaters RhB only needs to be large enough to generate heat energy for circulation of the ink in the individual channels 23. Moreover, in the case where the driving current of the circulation heaters RhB is smaller than the driving current of the ejection heaters RhA, the current driving performance of the circulation drive elements MD12 may be lower than the current driving performance of the ejection drive elements MD11. Accordingly, the area of the circulation drive elements MD12 is preferably smaller than the area of the ejection drive elements MD11. However, in the second comparative example, the ejection drive elements MD11 and the circulation drive elements MD12 are arranged to occupy the same area. Accordingly, as the print element substrate 300, excessive element size of the circulation drive elements MD12 may cause a cost increase.

### Third Case

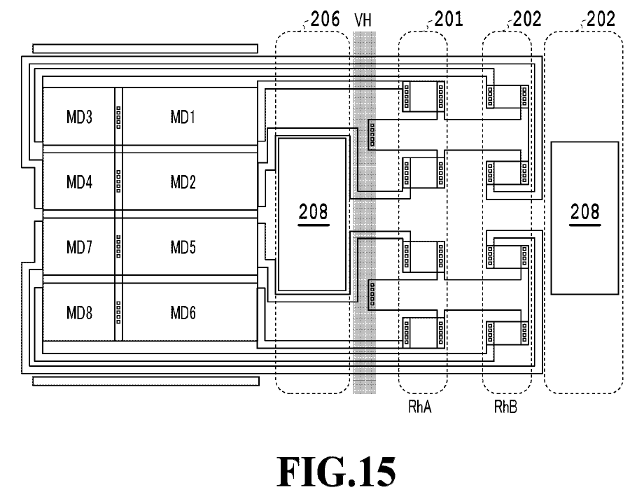

FIG. 15 is a diagram illustrating an arrangement example of the heaters and the drive elements in a third case according to the present embodiment. In FIG. 15, the ejection heaters RhA and the circulation heaters RhB are arranged in the print element substrate 300 as the heaters. In FIG. 15, ejection drive elements MD1, MD2, MD5, and MD6 and circulation drive elements MD3, MD4, MD7, and MD8 are arranged in the print element substrate 300 as the drive elements. In the first case and the second case, each pair of adjacent ejection drive elements MD1 and MD2 form one unit. Moreover, in the first case and the second case, each pair of adjacent circulation drive elements MD3 and MD4 form one unit. In the third case, two or more drive elements form one unit depending on an arrangement pitch of the supply orifices 208 of the ink and a pitch of the drive elements.

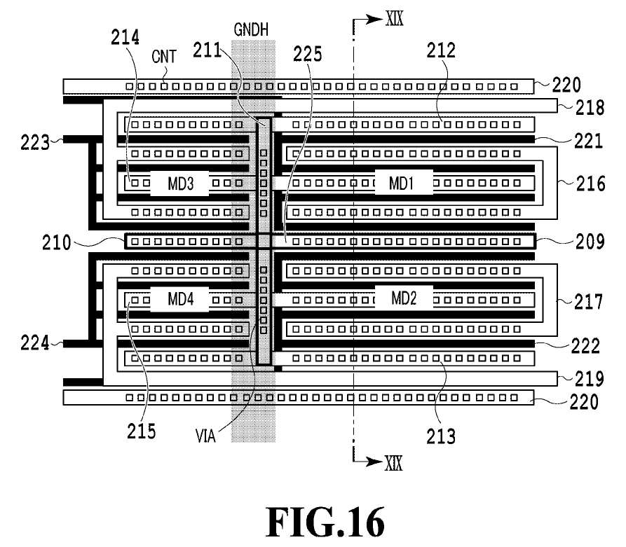

FIG. 15 illustrates an example in which four ejection heaters RhA and four circulation heaters RhB are arranged for two supply orifices 208 of the ink. Accordingly, the ejection drive elements MD1, MD2, MD5, and MD6 are grouped into one unit. Moreover, the circulation drive elements MD3, MD4, MD7, and MD8 are grouped into one unit. Specifically, four drive elements are grouped into one unit. This configuration is a configuration in which wiring lines from the circulation drive elements MD4 and MD7 to the circulation heaters RhB detour around an outermost periphery between the units. However, electrodes in boundary portions are shared by four drive elements in the unit. Accordingly, an increase of the drive element region can be suppressed. Next, details of the wiring configurations explained above are explained by using FIGS. 16 to 19.

### Details of Wiring Configuration; First Case

FIG. 16 is a diagram illustrating an enlarged example of the drive elements in the first case. In FIG. 16, the ejection drive elements MD1 and MD2 and the circulation drive elements MD3 and MD4 are illustrated as the drive elements. A gate electrode 221, a source electrode 212, and a drain electrode 216 are provided in the ejection drive element MD1. A gate electrode 222, a source electrode 213, and a drain electrode 217 are provided in the ejection drive element MD2. The source electrode 212 and the source electrode 213 are at the same electric potential. Moreover, the source electrode 212 and the source electrode 213 partially share the electrode in the shared ground electrode 209 via a shared ground electrode 211, and are connected to the ground line GNDH in the other wiring layer via the vias VIA.

A gate electrode 223, a source electrode 214, and a drain electrode 218 are provided in the circulation drive element MD3. A gate electrode 224, a source electrode 215, and a drain electrode 219 are provided in the circulation drive element MD4. The source electrode 214 and the source electrode 215 are at the same electric potential. Moreover, the source electrode 214 and the source electrode 215 partially share the electrode in the shared ground electrode 210 via the shared ground electrode 211, and are connected to the ground line GNDH in the other wiring layer via the vias VIA. Furthermore, the shared ground electrode 210 is electrically connected to the shared ground electrode 209 via a wiring line 225.

### Details of Wiring Configuration; Second Case

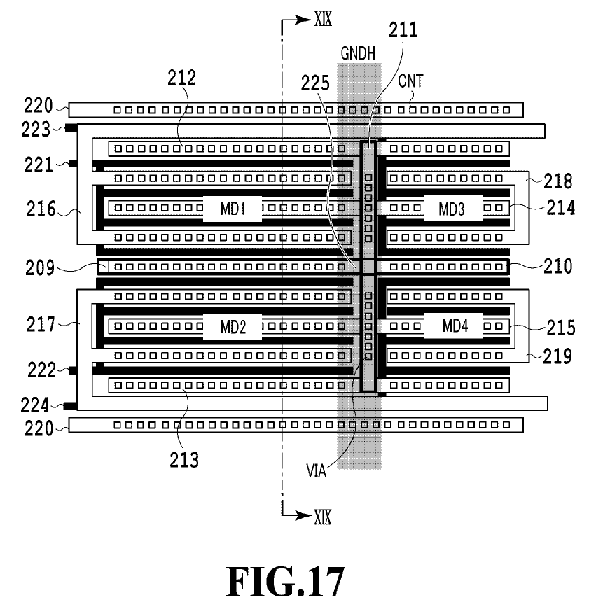

FIG. 17 is a diagram illustrating an enlarged example of the drive elements in the second case. As explained above, the positional relationship of the ejection drive elements MD1 and MD2 and the circulation drive elements MD3 and MD4 in the left-right direction is reversed. Accordingly, although the connection positions with the ground line GNDH via the vias VIA are shifted to the right, the basic arrangement of the source, the drain, and the gate electrodes of each drive element is the same as that in FIG. 16. Detailed explanation thereof is thus omitted.

### Details of Wiring Configuration; Second Comparative Example

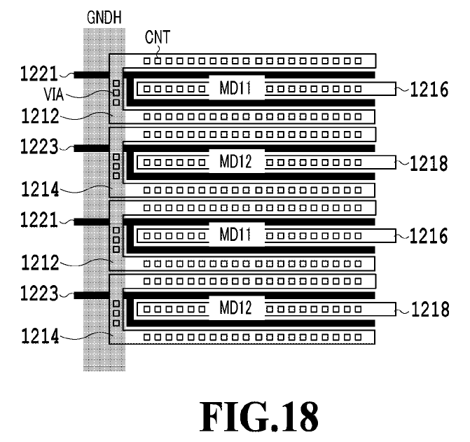

FIG. 18 is a diagram illustrating an enlarged example of the drive elements in the second comparative example. The ejection drive elements MD11 and the circulation drive elements MD12 are formed of a repeated pattern of source electrodes 1212 and 1214 and drain electrodes 1216 and 1218 in the array length direction. Accordingly, there is not much room for flexibility reducing only the area of the circulation drive elements MD12 by reducing the size in the array length direction. Meanwhile, there is a room for flexibility reducing the area of the circulation drive elements MD12 by reducing the size in the array width direction. Specifically, there is a room for flexibly reducing the sizes of the source electrodes 1214, the drain electrodes 1218, and gate electrodes 1223. However, regions formed by reducing the sizes in the array width direction do not contribute to downsizing of the print element substrate 300. Note that the wiring layer 1216 and the drain electrode 1216 are denoted by the same signs, and these elements are electrically connected to each other and are at the same potential. These terms are selectively used depending on the point of interest such as routing of the wiring line and a lead out portion of the electrode of the drive element.

### Details of Wiring Configuration; Cross-Sectional Structure

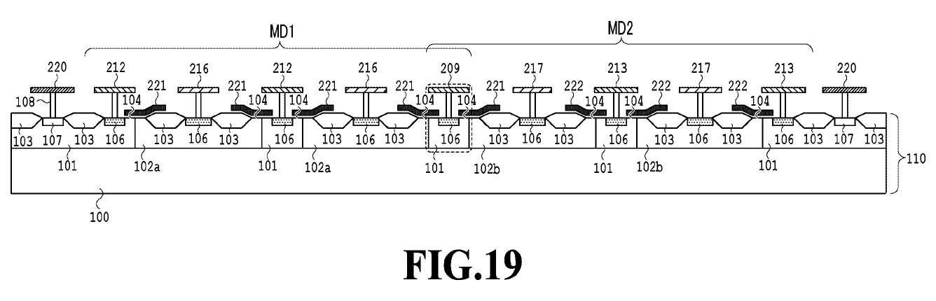

FIG. 19 is a diagram illustrating a cross-sectional structure along the XIX-XIX line in FIGS. 16 and 17. As illustrated in FIG. 19, in a semiconductor substrate 110, P-well regions 101 and N-well regions 102a and 102b are formed on a P-type silicon substrate 100. An impurity concentration of the N-well regions 102a and 102b with respect to the P-type silicon substrate 100 is such a concentration that a breakdown voltage between the N-well regions 102a and 102b and the P-type silicon substrate 100 is higher than a voltage applied to the power supply line VH.

Impurity concentrations of the P-well regions 101 and the N-well regions 102a and 102b are such concentrations that a breakdown voltage between the P-well regions 101 and the N-well regions 102a and 102b is higher than the voltage applied to the power supply line VH. Field oxide films 103, high-concentration N-type diffusion regions 106, and high-concentration P-type diffusion regions 107 are formed in the P-well regions 101 and the N-well regions 102a and 102b. The field oxide films 103 can be formed in, for example, a local oxidation of silicon (LOCOS) method.

### Configurations of Ejection Drive Elements MD1 and MD2

Configurations of the ejection drive elements MD1 and MD2 are explained. FIG. 19 illustrates an example in which the ejection drive elements MD1 and MD2 are formed of high-voltage tolerant NMOS transistors. The gate electrodes 221 and 222 are arranged on the P-well regions 101 and the N-well regions 102a and 102b adjacent to one another via gate insulation films 104. Regions where the P-well regions 101 and the gate electrodes 221 and 222 overlap one another are channel formation regions.

The high-concentration N-type diffusion regions 106 are source electrodes of the ejection drive elements MD1 and MD2. The high-concentration P-type diffusion regions 107 are back gate electrodes of the ejection drive elements MD1 and MD2. The back gate electrodes of the ejection drive elements MD1 and MD2 are at the same potential as the substrate contacts 220 of the ejection drive elements MD1 and MD2. The substrate contacts 220 are connected to the ground line GNDH via the wiring layer. Accordingly, the high-concentration P-type diffusion regions 107 are electrically connected to the ground line GNDH, and the reference potential is determined. The N-well regions 102a and 102b include portions extending below the gate electrodes 221 and 222 as field reduction regions of the drain electrodes. The high-concentration N-type diffusion regions 106 formed in the N-well regions 102a and 102b are the drain electrodes of the ejection drive elements MD1 and MD2. Moreover, the drain sides of the gate electrodes 221 and 222 have a so-called LOCOS offset structure that is a structure in which the drain sides of the gate electrodes 221 and 222 extend over the field oxide films 103 formed in the N-well regions 102a and 102b. A gate-drain breakdown voltage can be thereby secured also in the case where the ejection drive elements MD1 and MD2 are in an OFF state, that is in the case where the voltage of the drain electrodes rises to the voltage applied to the power supply line VH in the state where the voltage of the gate electrodes is GND.

The gate insulation films 104 can be formed in a manufacturing step of the semiconductor substrate 110. For example, the gate insulation films 104 can be formed of oxide films. Moreover, the gate electrodes 221 and 222 can be, for example, polysilicon layers. The polysilicon layers, the high-concentration N-type diffusion regions 106, and the high-concentration P-type diffusion regions 107 can be formed in the same step as a step of forming elements of the ejection drive elements MD1 and MD2 forming a logic circuit with a low tolerable level.

An insulation film provided with multiple contact portions 108 is provided on the high-concentration P-type diffusion regions 107, the high-concentration N-type diffusion regions 106, and the field oxide films 103. Conductive layers 212, 213, 216, 217, and 220 are provided on this insulation film. Each of the conductive layers 212, 213, 216, 217, and 220 can be formed of a metal such as, for example, aluminum. Note that the conductive layers, the electrodes, and the wiring lines only need to be electrically connected to one another, and manufacturing methods, materials, and structures thereof are not limited. Note that the conductive layer 212 and the source electrode 212 are denoted by the same sign, and these elements are electrically connected to each other and are at the same potential. These terms are used selectively depending on the point of interest of functions such as a cross-sectional structure and a lead out portion of the electrode from the drive element. The same applies to the conductive layer 213 and the source electrode 213. The same applies to the drain wiring line 216, the conductive layer 216, and the drain electrode 216. The same applies to the drain wiring line 217, the conductive layer 217, and the drain electrode 217. The same applies to the drain wiring line 218 and the drain electrode 218. The same applies to the drain wiring line 219 and the drain electrode 219. The same applies to the conductive layer 220 and the substrate contact 220. The same applies to the conductive layer 221 and the gate electrode 221.

In this example, the source electrodes of the ejection drive elements MD1 and MD2 share the P-well region 101, the high-concentration N-type diffusion region 106, the contact portion 108, and the conductive layer 221 via the shared ground electrode 209. In the case where the ejection drive element MD1 is in the ON state, a ON potential is applied to the gate electrode 221, and a current flows from the conductive layer 216 on the drain electrode side to the shared ground electrode 209. Meanwhile, in the case where the ejection drive element MD2 is in the ON state, the ON potential is applied to the gate electrode 222, and a current flows from the conductive layer 216 on the drain electrode side to the shared ground electrode 209. In the present embodiment, an example of the cross-sectional structure of the ejection drive elements MD1 and MD2 is explained. The circulation drive elements MD3 and MD4 also have a similar cross-sectional structure, and include the shared ground electrode 210. In the case of the cross-sectional structure of the circulation drive elements MD3 and MD4, no substrate contact 220 is arranged on both sides of the cross-sectional structure as illustrated in FIG. 19, and the drain wiring lines 216 and 217 to the ejection drive elements MD1 and MD2 are arranged on the both sides.

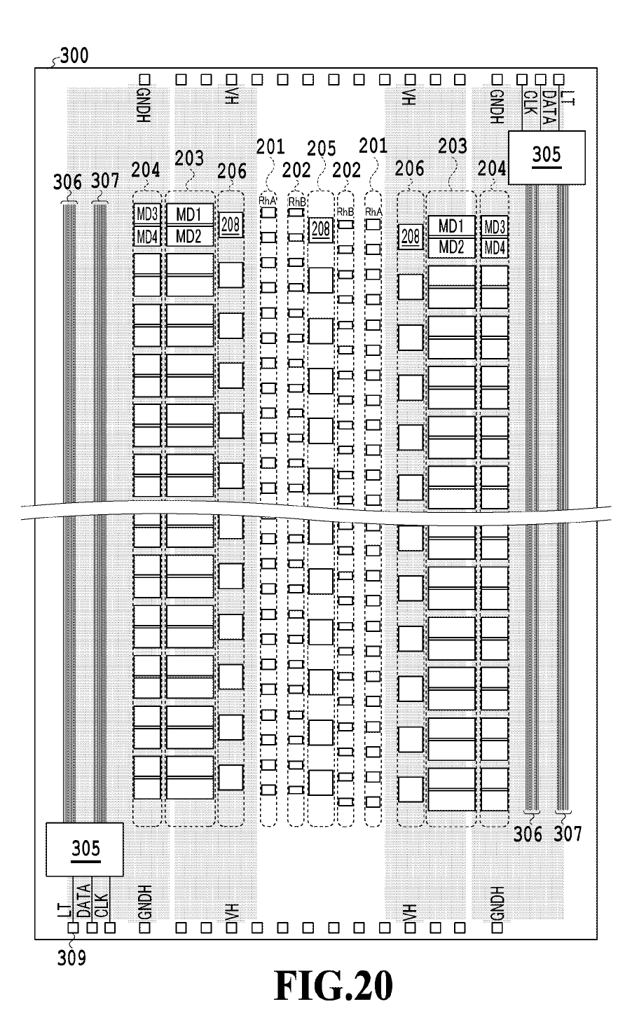

Note that, in the present embodiment, explanation is given of the example in which the source electrodes of the ejection drive elements MD1 and MD2 and the circulation drive elements MD3 and MD4 are at the same potential, and the shared ground electrodes 209 and 210 are provided. However, the present disclosure is not limited particularly to this example. For example, the configuration may be such that the drain electrode sides of the ejection drive elements MD1 and MD2 and the circulation drive elements MD3 and MD4 are connected in common to the power supply line VH, and the source electrode sides thereof are connected to the ejection heaters RhA and the circulation heaters RhB, respectively. Next, another circuit configuration example of the print element substrate 300 according to the present embodiment is explained by using FIG. 20.

### Another Circuit Configuration Example

FIG. 20 is a diagram illustrating another circuit configuration example of the print element substrate according to the present embodiment. FIG. 20 illustrates an example in which two arrays of the configuration of FIG. 11 are arranged point symmetric with respect to the center of the print element substrate 300. The group selection signal lines 306 and the time division selection signal lines 307 are arranged parallel to the ejection drive element arrays 203. Although the control data supply circuits 305 are arranged close to external connection terminal arrays 309, the control data supply circuits 305 may be arranged parallel to the group selection signal lines 306 along the array length direction. The two ejection heater arrays 201 arranged on the left and right sides about the center of the print element substrate 300 are arranged such that coordinates thereof in the array length direction are shifted from one another by a half-pitch with respect to a heater pitch. However, the coordinates may coincide with one another in the array length direction.

### Other Embodiments

Although various examples and the embodiment of the present disclosure have been illustrated and explained above, the spirit and the scope of the present disclosure are not limited to specific explanation of the present specification. The present disclosure is not limited to the above-mentioned embodiment, and various modifications can be made. Moreover, in the present disclosure, parts of the above-mentioned embodiment may be combined as appropriate.

### Modification 1

For example, although the example using the vias VIA for electrical connection with the other wiring layer is explained in the present embodiment, the present disclosure is not limited particularly to this example. For example, instead of the vias VIA achieving electrical conduction between one wiring layer and another wiring layer among multiple wiring layers stacked one on top of another, through holes achieving electrical conduction between all wiring layers may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

According to the present disclosure, it is possible to appropriately arrange the drive elements in the print element substrate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064382, filed Apr. 9, 2025, which is hereby incorporated by reference herein in its entirety.

What is claimed is:

1. A print element substrate comprising:
a heating resistance element group including a plurality of heating resistance elements being arranged; and
a drive element group including a plurality of drive elements configured to drive the plurality of heating resistance elements being arranged in a region on an identical layer as a heating element region included the plurality of heating resistance elements being arranged, wherein
the drive element group includes:
a first drive element array including a plurality of first drive elements being arranged in an array in a first region in a drive element region including the plurality of drive elements being arranged;
a second drive element array including a plurality of second drive elements different from the plurality of first drive elements, the plurality of second drive elements being arranged in an array in parallel with the first drive element array in a second region in the drive element region; and
one or more inter-array wiring layers arranged on the identical layer between the first drive element array and the second drive element array, the inter-array wiring layers shared by the first drive elements and the second drive elements.

2. The print element substrate according to claim 1, wherein
the first drive element array includes a plurality of first units each formed by grouping nearby first drive elements among the plurality of first drive elements into a unit,
the second drive element array includes a plurality of second units each formed by grouping nearby second drive elements among the plurality of second drive elements into a unit, and
the inter-array wiring layers are shared by the first units and the second units.

3. The print element substrate according to claim 2, wherein the inter-array wiring layers electrically connect a region shared by a path of a driving current of the first drive elements included in the first units and a path of a driving current of the second drive elements included in the second units.

4. The print element substrate according to claim 1, wherein
the heating resistance element group includes:
a first heating resistance element array in which a plurality of first heating resistance elements are arranged in an array in a first region of the heating element region, and
a second heating resistance element array in which a plurality of second heating resistance elements different from the plurality of first heating resistance elements are arranged in an array in parallel with the first heating resistance element array, in a second region of the heating element region,
the first heating resistance element array is arranged between the second heating resistance element array and the first drive element array, and
the first drive element array is arranged between the first heating resistance element array and the second drive element array.

5. The print element substrate according to claim 4, wherein
the first heating resistance elements generate energy for ejecting liquid in a liquid ejection head as ejection heaters, and
the second heating resistance elements generate energy for circulating liquid in the liquid ejection head as circulation heaters.

6. The print element substrate according to claim 4, further comprising:
a first wiring line group electrically connecting each of the first heating resistance elements and a corresponding one of the first drive elements to each other; and
a second wiring line group electrically connecting each of the second heating resistance elements and a corresponding one of the second drive elements to each other.

7. The print element substrate according to claim 1, wherein
the drive element group further includes:
first in-array wiring layers each shared by a corresponding one of groups of nearby first drive elements among the first drive elements along the first drive element array, and
second in-array wiring layers each shared by a corresponding one of groups of nearby second drive elements among the second drive elements along the second drive element array, and
the inter-array wiring layers, the first in-array wiring layers, and the second in-array wiring layers are electrically connected to one another.

8. The print element substrate according to claim 7, further comprising a ground line configured to set a reference potential and electrically connected to each of the inter-array wiring layers, the first in-array wiring layers, and the second in-array wiring layers.

9. The print element substrate according to claim 8, wherein the ground line is arranged in a layer different from the drive element region.

10. The print element substrate according to claim 4, wherein a magnitude relationship between areas of the first drive elements and the second drive elements is identical to a magnitude relationship between driving currents of the first heating resistance elements and the second heating resistance elements.

11. The print element substrate according to claim 6, further comprising a plurality of supply orifices configured to supply an ink, the plurality of supply orifices configured to be provided at predetermined intervals between the first drive element array and the first heating resistance element array, wherein
the first wiring line group and the second wiring line group are routed via peripheries of the supply orifices.
